(19) United States
(12) Patent Application Publication
(10) Pub. No.: US 2024/0034365 A1
(43) Pub. Date: Feb. 1, 2024

(54) PROCESSING METHOD, PROCESSING SYSTEM, STORAGE MEDIUM STORING PROCESSING PROGRAM, AND PROCESSING DEVICE

(71) Applicant: DENSO CORPORATION, Kariya-city, Aichi-pref. (JP)

(72) Inventors: TETSUYA TOHDO, Kariya-city (JP); SHIN KOSAKA, Kariya-city (JP)

(21) Appl. No.: 18/364,979

(22) Filed: Aug. 3, 2023

Related U.S. Application Data
(63) Continuation of application No. PCT/JP2022/004109, filed on Feb. 2, 2022.

(30) Foreign Application Priority Data
Feb. 5, 2021 (JP) 2021-017658

(51) Int. Cl. B60W 60/00; B60W 30/16

(52) U.S. Cl. CPC B60W 60/0057; B60W 60/0051; B60W 60/0015; B60W 30/16; B60W 2050/0083

(57) ABSTRACT

A processing method, implemented by at least one processor, includes: detecting a manual deviation between a driver's manual operation and a driver's standard operation when the host moving body is under manual-driving; and storing an acceptable response time for the host moving body. The acceptable response time is a response time during which the host moving body is allowed to respond while the manual deviation is generating. The acceptable response time is acquired based on a safety model that is a model in compliance with a driving policy and is formed by modeling a safety of intended functionality.

### CROSS REFERENCE TO RELATED APPLICATIONS

This application is a continuation application of International Patent Application No. PCT/JP2022/004109 filed on Feb. 2, 2022, which designated the U.S. and claims the benefit of priority from Japanese Patent Application No. 2021-017658 filed on Feb. 5, 2021. The entire disclosure of all of the above application is incorporated herein by reference.

### TECHNICAL FIELD

The present disclosure relates to processing technology for performing a process related to driving control of a host moving body.

### BACKGROUND

Driving control related to a navigation operation of a host vehicle is planned in accordance with detection information related to an internal and external environment of the host vehicle. Therefore, when it is determined, based on a safety model generated corresponding to a driving policy and detected information, that the vehicle is potentially responsible for an accident, a safety restriction/constraint is given to driving control of the vehicle. This safety restriction takes into account a response time of each of the host and target vehicles.

### SUMMARY

One aspect of the present disclosure is a processing method executed by a processor for executing a process related to driving control of a host moving body. The method includes: detecting a manual deviation between a driver's manual operation and a driver's standard operation when the host moving body is under manual-driving; and outputting an acceptable response time for the host moving body. The acceptable response time is a response time during which the host moving body is allowed to respond while the manual deviation is generating. The acceptable response time is acquired based on a safety model that is a model in compliance with a driving policy and is formed by modeling a safety of intended functionality.

### BRIEF DESCRIPTION OF DRAWINGS

FIG. 1 is an explanatory table showing an explanation of terms in the present disclosure.

FIG. 2 is an explanatory table showing an explanation of terms in the present disclosure.

FIG. 3 is an explanatory table showing an explanation of terms in the present disclosure.

FIG. 4 is an explanatory table showing an explanation of terms in the present disclosure.

FIG. 5 is an explanatory table showing an explanation of terms in the present disclosure.

FIG. 6 is a block diagram showing a processing system according to a first embodiment.

FIG. 7 is a schematic diagram showing a traveling environment of a host vehicle according to the first embodiment.

FIG. 8 is a block diagram showing the processing system according to the first embodiment.

FIG. 9 is a schematic diagram showing an example of a lane structure according to the first embodiment.

FIG. 10 is a flowchart showing a processing method according to the first embodiment.

FIG. 11 is a flowchart showing a processing method according to a second embodiment.

FIG. 12 is a block diagram showing a processing system according to a third embodiment.

FIG. 13 is a flowchart showing a processing method according to the third embodiment.

FIG. 14 is a flowchart showing a processing method according to a fourth embodiment.

FIG. 15 is a block diagram showing a processing system according to a fifth embodiment.

FIG. 16 is a flowchart showing a processing method according to the fifth embodiment.

FIG. 17 is a flowchart showing a processing method according to a sixth embodiment.

FIG. 18 is a block diagram showing a processing system according to a seventh embodiment.

FIG. 19 is a block diagram showing a processing system according to a seventh embodiment.

FIG. 20 is a block diagram showing a processing system according to an eighth embodiment.

FIG. 21 is a flowchart showing a processing method according to the eighth embodiment.

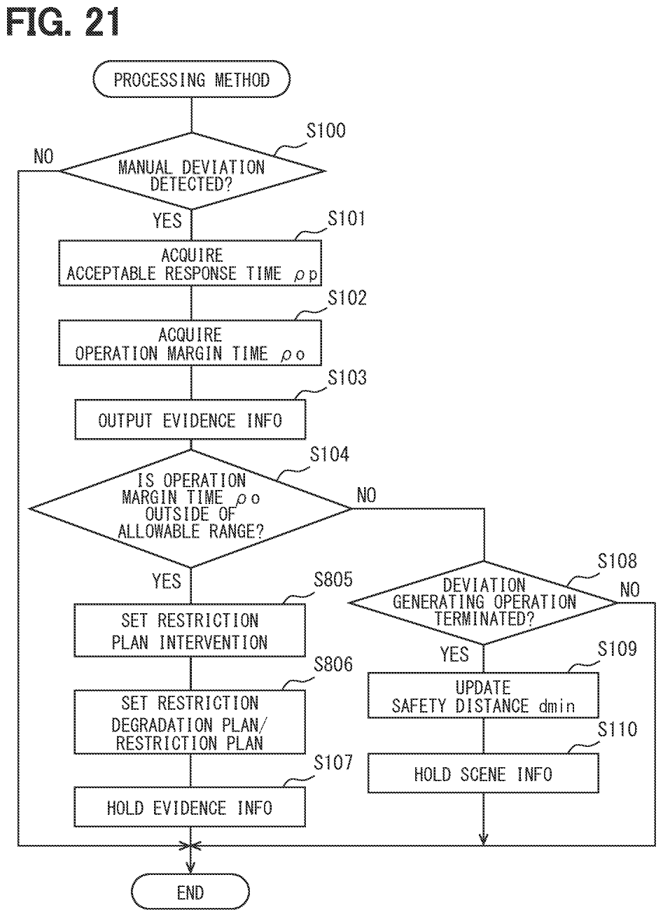

FIG. 22 is a flowchart showing a processing method according to a ninth embodiment.

### DESCRIPTION OF EMBODIMENTS

To begin with, a relevant technology will be described only for understanding the following embodiments. Typical technology assumes a response time for the host vehicle during automatic driving. Further, such technology tends to assume a common reaction time for the host vehicle and the target vehicle. Under these assumptions, it may be difficult to ensure the accuracy of operation control.

One of objectives of the present disclosure is to provide a processing method for ensuring an accuracy of driving control. Another object of the present disclosure is to provide a processing system for ensuring an accuracy of driving control. Yet another object of the present disclosure is to provide a program for ensuring an accuracy of driving control. Yet another object of the present disclosure is to provide a processing device for ensuring an accuracy of driving control.

A first aspect of the present disclosure is a processing method executed by a processor for executing a process related to driving control of a host moving body. The method includes: detecting a manual deviation between a driver's manual operation and a driver's standard operation when the host moving body is under manual-driving; and outputting an acceptable response time for the host moving body. The acceptable response time is a response time during which the host moving body is allowed to respond while the manual deviation is generating. The acceptable response time is acquired based on a safety model that is a model in compliance with a driving policy and is formed by modeling a safety of intended functionality.

A second aspect of the present disclosure is a processing system that is configured to execute a process related to driving control of a host moving body. The system includes: at least one processor programmed to: detect a manual deviation between a driver's manual operation and a driver's standard operation when the host moving body is under manual-driving; and output an acceptable response time for the host moving body. The acceptable response time is a response time during which the host moving body is allowed to respond while the manual deviation is generating. The acceptable response time is acquired based on a safety model that is a model in compliance with a driving policy and is formed by modeling a safety of intended functionality.

A third aspect of the present disclosure is a processing program stored in a storage medium and includes instructions causing at least one processor to execute a process related to driving control of a host moving body. The instructions, when executed by the at least one processor, case the at least one processor to: detect a manual deviation between a driver's manual operation and a driver's standard operation when the host moving body is under manual-driving; and output an acceptable response time for the host moving body. The acceptable response time is a response time during which the host moving body is allowed to respond while the manual deviation is generating. The acceptable response time is acquired based on a safety model that is a model in compliance with a driving policy and is formed by modeling a safety of intended functionality.

A fourth aspect of the present disclosure is a processing device that is installable in a host moving body and executes a process related to driving control of the host moving body. The device includes: at least one processor programmed to: detect a manual deviation between a driver's manual operation and a driver's standard operation when the host moving body is under manual-driving; and output an acceptable response time for the host moving body. The acceptable response time is a response time during which the host moving body is allowed to respond while the manual deviation is generating. The acceptable response time is acquired based on a safety model that is a model in compliance with a driving policy and is formed by modeling a safety of intended functionality.

According to the first to fourth aspects, when the manual deviation, which is a deviation of the manual operation by the driver from the driver's standard operation, is generating in the host moving body under the manual-driving, the allowable reaction time for the host moving body is acquired based on the safety model that is a model in accordance with the driving policy and is formed by modeling the safety of intended functionality and the acquired allowable reaction time is output. Accordingly, it is possible to assume an allowable reaction time that is specific to a scene in which the manual deviation generates, and thus the accuracy of the driving control can be secured by setting an appropriate restriction (or constraint) on the host moving body under the manual-driving.

A fifth aspect of the present disclosure is a processing method executed by a processor for executing a process related to driving control of a host moving body. The method includes: detecting a target moving body that is following the host moving body under automated-driving; and outputting an acceptable response time. The acceptable response time is a response time during which the target moving body is allowed to respond. The acceptable response time is acquired based on a safety model that is a model in compliance with a driving policy and is formed by modeling a safety of intended functionality.

A sixth aspect of the present disclosure is a processing system that is configured to execute a process related to driving control of a host moving body. The system includes: at least one processor programmed to: detect a target moving body that is following the host moving body under automated-driving; and output an acceptable response time. The acceptable response time is a response time during which the target moving body is allowed to respond. The acceptable response time is acquired based on a safety model that is a model in compliance with a driving policy and is formed by modeling a safety of intended functionality.

A seventh aspect of the present disclosure is a processing program stored in a storage medium and includes instructions causing at least one processor to execute a process related to driving control of a host moving body. The instructions, when executed by the at least one processor, causes the at least one processor to: detect a target moving body that is following the host moving body under automated-driving; and output an acceptable response time. The acceptable response time is a response time during which the target moving body is allowed to respond. The acceptable response time is acquired based on a safety model that is a model in compliance with a driving policy and is formed by modeling a safety of intended functionality.

An eighth aspect of the present disclosure is a processing device that is installable in a host moving body and executes a process related to driving control of the host moving body. The device includes: at least one processor programmed to: detect a target moving body that is following the host moving body under automated-driving; and output an acceptable response time. The acceptable response time is a response time during which the target moving body is allowed to respond. The acceptable response time is acquired based on a safety model that is a model in compliance with a driving policy and is formed by modeling a safety of intended functionality.

According to the fifth to eighth aspects, when the target moving body is following the host moving body under the automated-driving, the allowable reaction time for the target moving body is acquired based on the safety model that is a model in accordance with the driving policy and is formed by modeling the safety of intended functionality and the acquired allowable reaction time is output. Accordingly, it is possible to assume an allowable reaction time that is specific to a following scene in which the following moving body is following the host moving body, and thus the accuracy of the driving control can be secured by setting an appropriate restriction (or constraint) on the host moving body under the manual-driving.

Hereinafter, various embodiments of the present disclosure will be described with reference to the drawings. Note that the same reference numerals are given to corresponding components in each embodiment, and redundant description may be omitted. When only a part of the configuration is described in the respective embodiments, the configuration of the other embodiments described before may be applied to other parts of the configuration. Further, not only the combinations of the configurations explicitly shown in the description of the respective embodiments, but also the configurations of the plurality of embodiments can be partially combined together even if the configurations are not explicitly shown if there is no problem in the combination in particular.

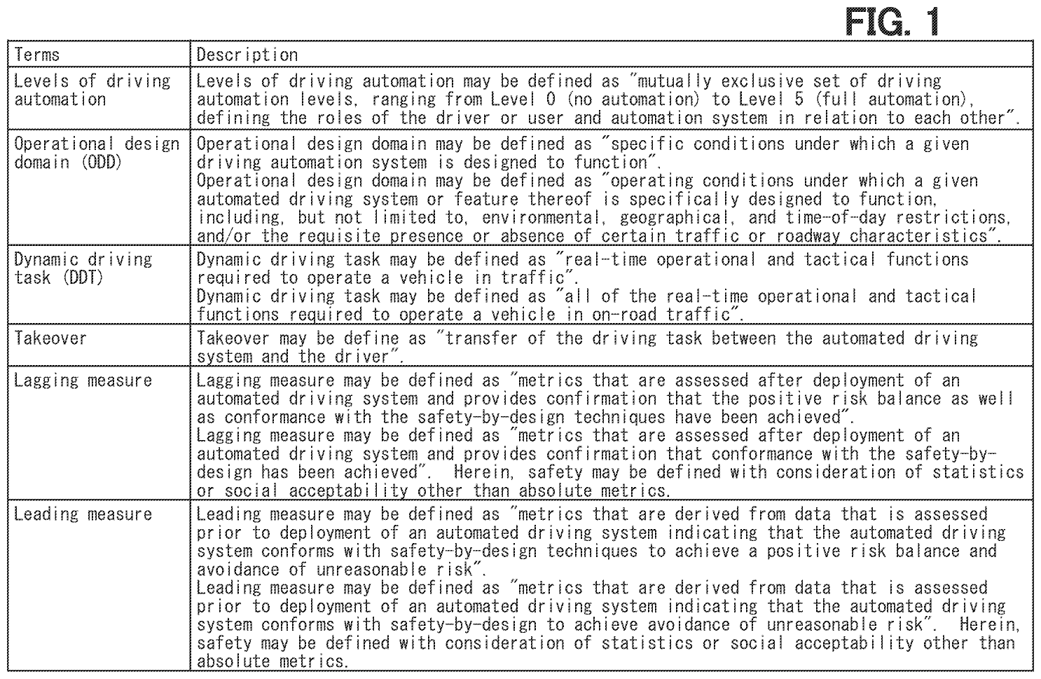

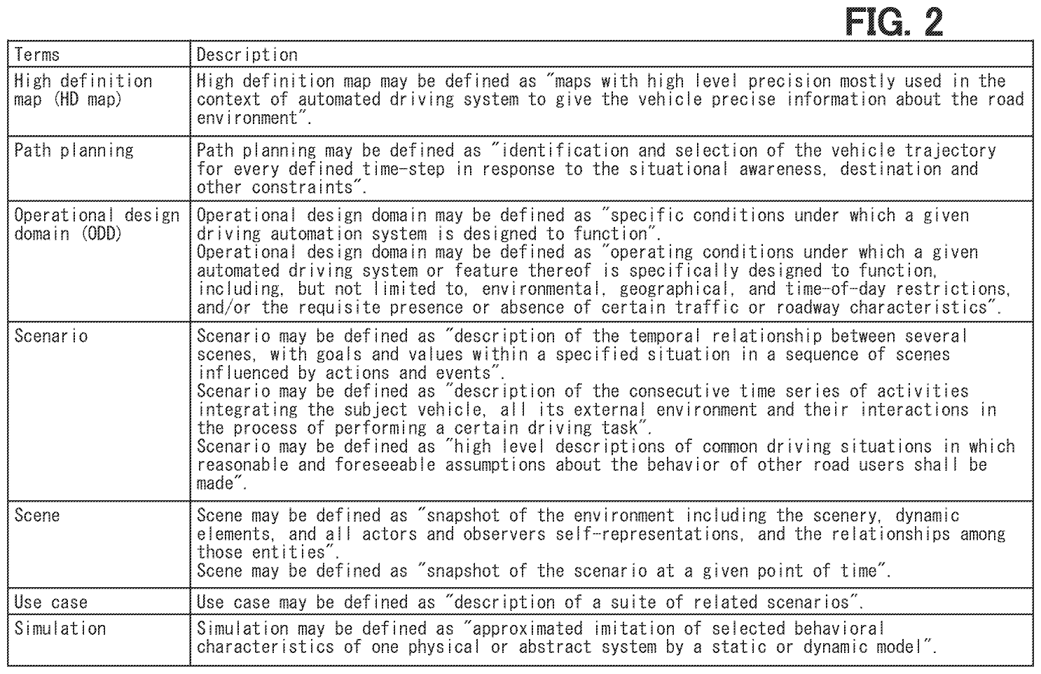

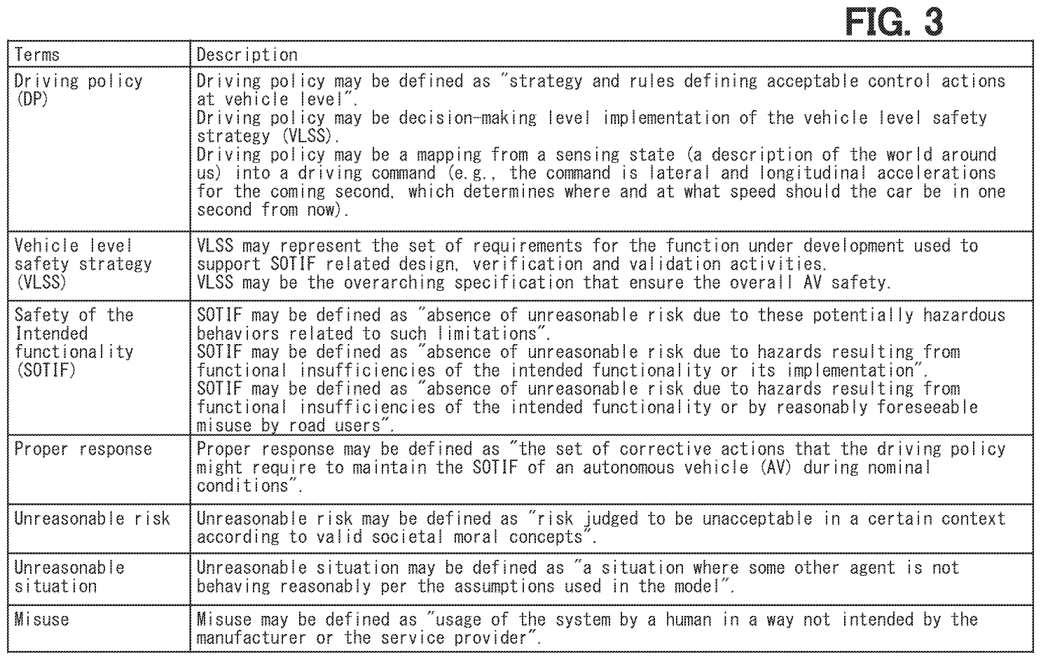

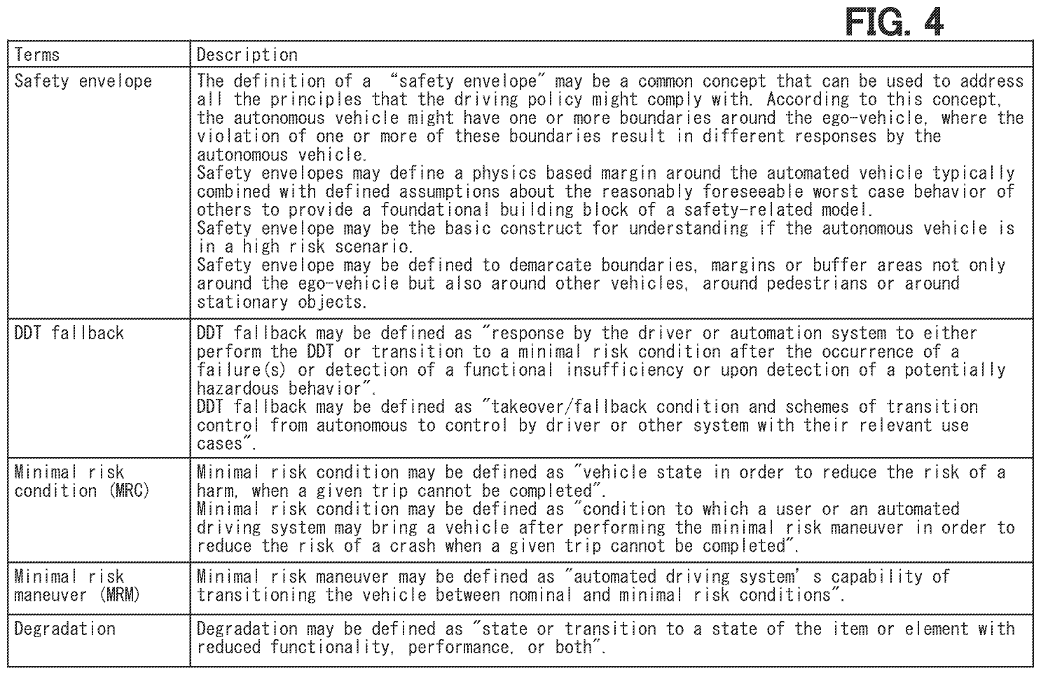

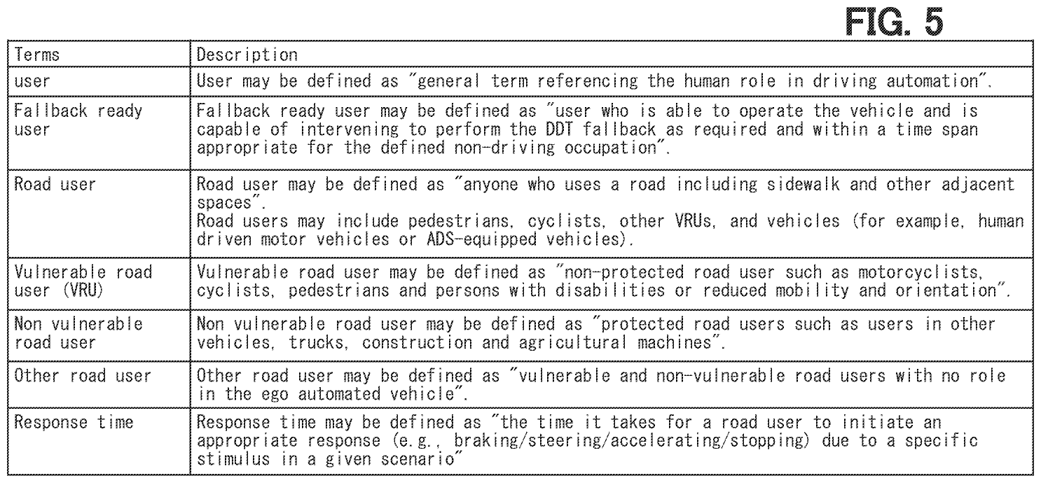

FIGS. 1-5 provide explanations of terms associated with each embodiment of the present disclosure. However, the definitions of terms should not be construed as being limited to the explanations shown in FIGS. 1-5 and should be construed within a scope unless the interpretation deviates the points of the present disclosure.

### First Embodiment

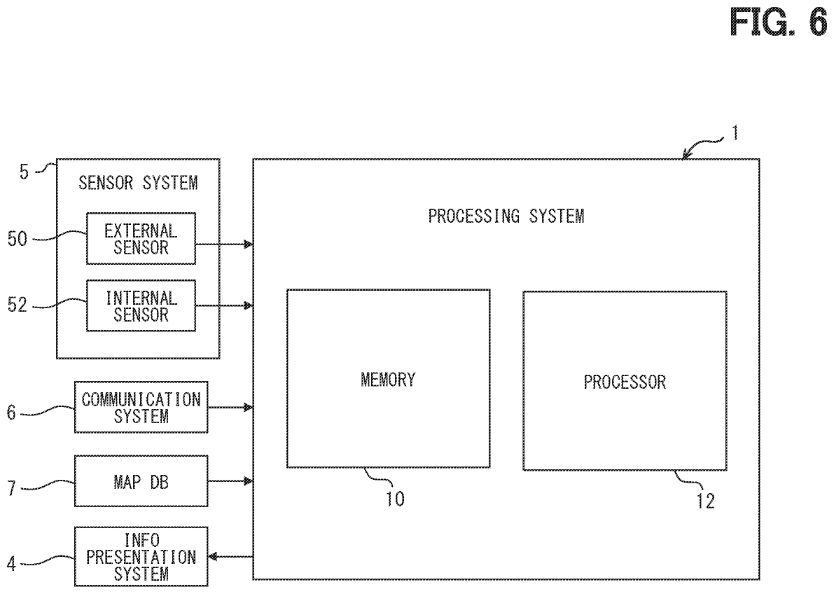

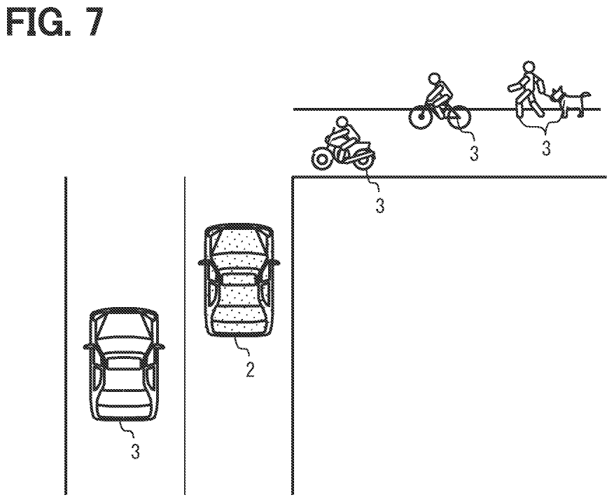

A processing system 1 in the first embodiment illustrated in FIG. 6 performs a process related to driving control of a host moving body (hereinafter, referred to as an “driving control process”). The host moving body which is a control target by the processing system 1 is a host vehicle 2 shown in FIG. 7. From the perspective of the host vehicle 2, the host vehicle 2 may be referred to as an ego-vehicle.

Automated-driving is executed in the host vehicle 2. The automated-driving is classified into levels according to the degree of manual intervention by the driver in a dynamic driving task (hereinafter, referred to as “DDT”). The automated-driving may be achieved with an autonomous travel control, such as conditional driving automation, advanced driving automation, or full driving automation, where the system in operation performs all the DDTs. The automated-driving may be realized in advanced driving assistance control, such as driving assistance or partial driving automation, where the driver as a passenger performs some or all of the DDTs. The automated-driving may be realized by either one or combination of autonomous driving control and advanced driving assistance control or switching between the autonomous control and advanced driving assistance control.

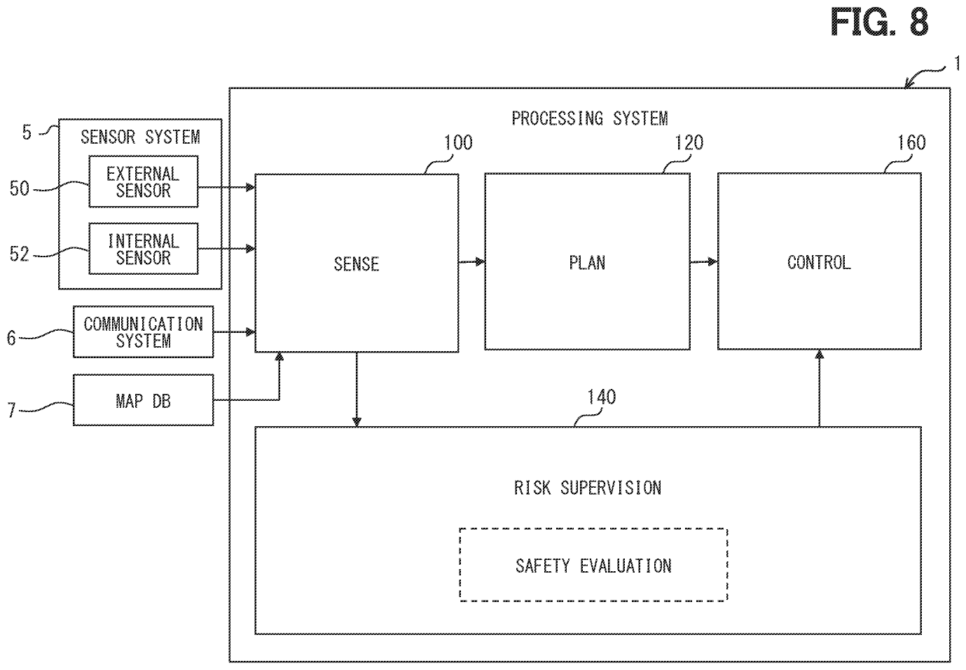

The host vehicle 2 is equipped with a sensor system 5, a communication system 6, a map DB (Data Base) 7, and an information presentation system 4 as shown in FIGS. 6 and 8. The sensor system 5 acquires sensor data that may be used by the processing system 1 by detecting an environment outside or inside of the host vehicle 2. Therefore, the sensor system 5 includes an external sensor 50 and an internal sensor 52.

The external sensor 50 may detect an object existing in the external environment of the host vehicle 2. The external sensor 50 of an object detection type is at least one of a camera, a LIDAR (Light Detection and Ranging/Laser Imaging Detection and Ranging), a laser radar, a millimeter wave radar, an ultrasonic sonar, and the like, for example. The external sensor 50 may detect a condition of the atmosphere in the external environment of the host vehicle 2. The external sensor 50 of an atmosphere detection type is at least one of, for example, an external temperature sensor and a humidity sensor.

The internal sensor 52 may detect a particular physical quantity related to vehicle motion (hereinafter, referred to as a kinetic physical quantity) in the internal environment of the host vehicle 2. The internal sensor 52 of a physical quantity detection type is at least one of, for example, a speed sensor, an acceleration sensor, a gyro sensor, and the like. The internal sensor 52 may detect a condition of an occupant in the internal environment of the host vehicle 2. The internal sensor 52 of an occupant detection type is at least one of, for example, an actuator sensor, a driver status monitor, a biosensor, a seating sensor, an in-vehicle device sensor, and the like. Here, as the actuator sensor in particular, at least one of an accelerator sensor, a brake sensor, a steering sensor, or the like, which detects an operating state of the occupant regarding a motion actuator of the host vehicle 2, is used.

The communication system 6 acquires, via wireless communication, communication data that may be used by the processing system 1. The communication system 6 may receive positioning signals from artificial satellites of a GNSS (Global Navigation Satellite System) that is outside of the host vehicle 2. The communication system 6 of a positioning type is, for example, a GNSS receiver or the like. The communication system 6 may transmit and receive communication signals with a V2X system that is outside of the host vehicle 2. The V2X type communication system 6 is, for example, at least one of a DSRC (Dedicated Short Range Communications) communication device, a cellular V2X (C-V2X) communication device, and the like. The communication system 6 may transmit and receive communication signals with a terminal device that is inside of the host vehicle 2. The communication system 6 of a terminal communication type is, for example, at least one of Bluetooth (registered trademark) equipment, Wi-Fi (registered trademark) equipment, infrared communication equipment, and the like.

The map DB 7 stores map data that may be used by the processing system 1. The DB 7 includes at least one type of non-transitory tangible storage medium such as a semiconductor memory, a magnetic medium, and an optical medium. The map DB 7 may be a database of locators for estimating state quantities of the host vehicle 2, including its own position. The map DB 7 may be a database of a navigation unit for navigating the route of the host vehicle 2. The map DB 7 may be formed by the combination of multiple types of DB.

The map DB 7 acquires and stores the latest map data through communication with an external center via the V2X type communication system 6, for example. The map data is two-dimensional or three-dimensional data representing a traveling environment of the host vehicle 2. Digital data of a high-precision map may be used as the three-dimensional map data. The map data may include road data representing at least one of positional coordinates of a road structure, shape, road surface condition, and the like of the road. The map data may include, for example, marking data representing at least one type of position coordinates, shape, or the like of a road sign, a road marking, and a lane marking that are attached to the road. The marking data included in the map data may represent a traffic sign, an arrow marking, a lane marking, a stop line, a direction sign, a landmark beacon, a rectangular sign, a business sign, a line pattern change of the road, and the like of a landmark. The map data may include, for example, structure data representing at least one of the position coordinates and shapes of buildings and traffic lights facing roads. The marking data included in the map data may represent a streetlight, an edges of a road, a reflector, a pole, or a back side of the road sign of a landmark.

The information presentation system 4 presents notification information to a passenger including the driver of the host vehicle 2. The information presentation system 4 includes a visual presentation unit, an auditory presentation unit, and a tactile presentation unit. The visual presentation unit presents notification information by stimulating the visual sense of an occupant. The visual presentation unit is at least one of, for example, a HUD (Head-up Display), an MFD (Multi Function Display), a combination meter, a navigation unit, a light emitting unit, and the like. The auditory presentation unit presents notification information by stimulating the auditory sense of an occupant. The auditory presentation unit is, for example, at least one type of speaker, buzzer, vibration unit, and the like. The tactile presentation unit presents notification information by stimulating the passenger's cutaneous (tactile) sensations. The cutaneous sensation stimulated by the tactile presentation unit includes at least one of touch, temperature, wind, and the like. The tactile presentation unit is, for example, at least one of a steering wheel vibration unit, a driver's seat vibration unit, a steering wheel reaction force unit, an accelerator pedal reaction force unit, a brake pedal reaction force unit, and an air conditioning unit.

As shown in FIG. 6, the processing system 1 is connected to the sensor system 5, the communication system 6, the map DB 7, and the information presentation system 4 via at least one of a LAN (Local Area Network), a wire harness, an internal bus, a wireless communication line, and the like. The processing system 1 includes at least one dedicated computer. The dedicated computer that constitutes the processing system 1 may be an integrated ECU (Electronic Control Unit) that integrates operation control of the host vehicle 2. The dedicated computer that constitutes the processing system 1 may be a determination ECU that is configured to decide the DDT for the operation control of the host vehicle 2. The dedicated computer that constitutes the processing system 1 may be a monitoring ECU that monitors the operation control of the host vehicle 2. The dedicated computer that constitutes the processing system 1 may be an evaluation ECU that evaluates the operation control of the host vehicle 2.

The dedicated computer that constitutes the processing system 1 may be a navigation ECU that navigates the travel route of the host vehicle 2. The dedicated computer that constitutes the processing system 1 may be a locator ECU that estimates a state quantity of the host vehicle including the position of the host vehicle 2. The dedicated computer that constitutes the processing system 1 may be an actuator ECU that controls motion actuators of the host vehicle 2. The dedicated computer that constitutes the processing system 1 may be an HCU (i.e., Human Machine Interface Control Unit, HMI Control Unit) that controls information presentation in the host vehicle 2. The dedicated computer that constitutes the processing system 1 may be at least one external computer that constructs an external center or a mobile terminal device that is configured to perform communication via the communication system 6, for example.

The dedicated computer of the processing system 1 has at least one memory 10 and at least one processor 12. The memory 10 is at least one type of non-transitory tangible storage medium, such as a semiconductor memory, a magnetic medium, and an optical medium, for non-transitory storage of computer readable programs and data. The processor 12 includes, as a core, at least one type of, for example, a CPU (Central Processing Unit), a GPU (Graphics Processing Unit), an RISC (Reduced Instruction Set Computer) CPU, and the like.

The processor 12 executes multiple instructions included in a processing program stored in the memory 10 as software. Accordingly, the processing system 10 works as a number of functional blocks to carry out travel control processing for the host vehicle 2. As described above, in the processing system 1, the functional blocks are formed by the processor 12 executing multiple instructions of processing programs stored in the memory 10 for performing the driving control processing for the host vehicle 2. The functional blocks realized by the processing system 1 include a sensing block 100, a planning block 120, a risk supervising block 140, and a control block 160 as shown in FIG. 8.

The sensing block 100 acquires sensor data from the external sensor 50 and the internal sensor 52 in the sensor system 5. The sensing block 100 acquires communication data from the communication system 6. The sensing block 100 acquires map data from the map DB 7. The sensing block 100 senses internal and external environments of the host vehicle 2 by fusing these acquired data as an input. By detecting the internal and external environment, the sensing block 100 generates detection information to be transmitted to the planning block 120 and the risk supervising block 140 in a latter stage. In this way, in generating the detection information, the sensing block 100 acquires data from the sensor system 5 and the communication system 6, recognizes or understands the meaning of the acquired data, and determines its situation in the external environment and the internal environment of the host vehicle 2 and general situations including the internal environment condition of the host vehicle 2 by integrating the acquired data. The sensing block 100 may provide substantially the same detection information to both planning block 120 and risk supervising block 140. The sensing block 100 may provide different detection information to each of planning block 120 and risk supervising block 140.

The detection information generated by the sensing block 100 describes the state of a traveling environment detected for each scene for the host vehicle 2. The sensing block 100 may detect objects, including road users, obstacles, and structures in the environment outside of the host vehicle 2 to generate the detection information of the objects. The object detection information may represent at least one of, for example, the distance to the object, the relative velocity of the object, the relative acceleration of the object, and the estimated state based on tracking detection of the object. The detection information of the object may further represent the type recognized or identified from the state of the detected object. The sensing block 100 may generate the detection information of a travel route by detecting the travel route along which the host vehicle 2 is currently traveling and will be traveling in future. The detection information of the travel route may represent, for example, at least one of states among a road surface, a lane, a roadside, a free space, and the like.

The sensing block 100 may generate detection information of a self-state quantity including position information of the host vehicle 2 by localization to presumptively detect the self-state quantity. The sensing block 100 may generate update information of the map data regarding the travel route of the host vehicle 2 at the same time as generating the detection information of the self-state quantity, and provide the updated information to the map DB 7 as feedback. The sensing block 100 may detect a sign associated with the travel route of the host vehicle 2 to generate the detection information of the sign. The detection information of the sign may represent the state of at least one of, for example, a sign, a lane marking, a traffic light, and the like. The detection information of the sign may also represent a traffic rule that is recognized or identified from the state of the sign. The sensing block 100 may generate the detection information of a weather condition by detecting the weather condition for each scene in which the host vehicle 2 is traveling. The sensing block 100 may generate the detection information of a time by detecting the time for each driving scene of the host vehicle 2.

The planning block 120 acquires the detection information from the sensing block 100. The planning block 120 plans driving control of the host vehicle 2 according to the acquired detection information. At the driving control planning, control commands for the navigation and driver assistance actions for the host vehicle 2 are generated. That is, the planning block 120 implements a DDT function that generates a control command as a motion control request for host vehicle 2. The control command generated by the planning block 120 may include control parameters for controlling motion actuators of the host vehicle 2. The motion actuators to which control commands are output include, for example, at least one of an internal combustion engine, an electric motor, a power train in which these are combined, a braking device, a steering device, and the like.

The planning block 120 may use a safety model described according to a driving policy and its safety to generate control commands in compliance with the driving policy. The driving policy according to the safety model is defined, for example, based on a vehicle-level safety strategy that guarantees Safety Of The Intended Functionality (hereinafter, referred to as SOTIF). In other words, the safety model is described by following the driving policy that implements a vehicle-level safety strategy and by modeling the SOTIF. The planning block 120 may train the safety model with a machine learning algorithm that performs backpropagations of operational control results to the safety model. As the safety model to be trained, at least one type of a learning model may be used among deep learning by a neural network such as DNN (Deep Neural Network), reinforcement learning, and the like. The safety model may be defined here as safety-related models that express safety-related aspects of driving behaviors based on an assumption about reasonably foreseeable behaviors of other road users. Alternatively, the safety model may be defined as a model forming part of the safety-related models. Such a safety model may be formed in at least one form of, for example, a mathematical model that formulates vehicle-level safety or a computer program that executes processes according to the mathematical model.

The planning block 120 may make a plan for the future route along which the host vehicle 2 will be traveled by the travel control prior to generating the control commands. The route planning may be performed computationally, for example, by simulation to navigate the host vehicle 2 based on the detection information. That is, the planning block 120 may implement a DDT function to plan a route as a strategic action of the host vehicle 2. The planning block 120 may also plan a proper trajectory based on the acquired detection information for the host vehicle 2 following the planned route prior to generating the control commands. That is, the planning block 120 may implement a DDT function to plan a trajectory for the host vehicle 2. The trajectory planned by the planning block 120 may define chronologically at least one of a traveling position, a speed, a acceleration, and a yaw rate as a kinetic physical quantity relating to the host vehicle 2. The chronological trajectory plan builds a scenario of future travel for the host vehicle 2 by navigation. The planning block 120 may generate the trajectory based on a plan using the safety model. In this case, the safety model may be trained by a machine learning algorithm based on computation results by computing a cost function that gives a cost to the generated trajectory.

The planning block 120 may make a plan for adjusting the automated-driving level for the host vehicle 2 according to the acquired detection information. Adjusting the automated-driving level may also include handover between automated-driving and manual-driving. By setting Operational Design Domain (hereinafter, referred to as ODD) where the automated-driving is executed, the handover between automated-driving and manual-driving is realized in a scenario involving entering or exiting the ODD. The exiting scenario from the ODD, that is, the handover scenario from automated-driving to manual-driving includes, as a use case, an unreasonable situation in which an unreasonable risk is determined to exist based on, for example, a safety model. In this use case, the planning block 120 may plan a DDT fallback for the driver who is a fallback reserve user to give a minimum risk maneuver to the host vehicle 2 to cause the host vehicle 2 to shift to a minimum risk state.

Adjusting the automated-driving level may include a degraded operation of the host vehicle 2. In the degraded operation scenario, an unreasonable situation is included as a use case where an unreasonable risk is determined to exist due to handover to manual-driving based on, for example, a safety model. In the use case, the planning block 120 may plan a DDT fallback to cause the host vehicle 2 to transition to a minimum risk state through autonomous driving and autonomous stopping. The DDT fallback for causing the host vehicle 2 to transition to the minimum risk state is not only realized by adjusting the automated-driving level, but also adjustment such as MRM (Minimum Risk Maneuver) or the like to perform a degraded operation while maintaining the automated-driving level. The DDT fallback for causing the host vehicle 2 to transition to the minimum risk state may enhance the prominence of the transition situation by at least one of, for example, lighting, horns, signals, and gestures.

The risk supervising block 140 acquires the detection information from the sensing block 100. The risk supervising block 140 monitors a risk between the host vehicle 2 and other target moving bodies 3 (see FIG. 7) for each scene based on the acquired detection information. The risk supervising block 140 chronologically performs risk monitoring based on the detection information so as to guarantee the SOTIF of the host vehicle 2 with respect to the target moving body 3. The target mobile object 3 assumed in risk monitoring is another road user present in the travel environment of the host vehicle 2. The target moving bodies 3 include non-vulnerable road users such as automobiles, trucks, motorbikes, and bicycles, and vulnerable road users such as pedestrians. The target moving body 3 may further include an animal.

The risk supervising block 140 sets, based on the acquired scene-by-scene detection information, a safety envelope that ensures the SOTIF in the host vehicle 2 based on, e.g., a vehicle-level safety strategy. The risk supervising block 140 may set the safety envelope between the host vehicle 2 and the target vehicle 3 using the safety model in accordance with the driving policy as described above. The safety model used to set the safety envelope may be designed to avoid, in accordance with accident liability rules, potential accident liability resulting from an unreasonable risk or road user misuse. In other words, the safety model may be designed such that the host vehicle 2 complies with the accident liability rules according to the driving policy. Such a safety model includes, for example, a Responsibility Sensitive Safety model as disclosed in JP 6,708,793 B, which is incorporated herein by reference.

The safety envelope may be defined herein as a series of limitations and conditions under which the system is designed to act as a target of a constraint or control to maintain operation within an acceptable level of risk. Such a safety envelope may be defined as a physical-based margin around each road user including the host vehicle 2 and the target vehicle 3. The safety envelope may be set with a margin relating to at least one physical quantity such as a distance, velocity, or acceleration. For example, in setting the safety envelope, a safety distance may be assumed from a profile relating to at least one kinematic quantity, based on the safety model for the host vehicle 2 and the target vehicle 3 that are assumed to comply with the driving policy. The safety distance defines a physical-based marginal boundary around the host vehicle 2 for the expected motion of the target vehicle 3. The safety distance may be assumed in view of the reaction time until an appropriate response is taken by the road user. The safety distance may be assumed to comply with accident liability regulations. For example, in a scene with a lane structure such as lanes, there is a safety distance in the longitudinal direction of the host vehicle 2 for avoiding the risk of rear-end collision and head-on collision and a safety distance in the lateral direction of the host vehicle 2 for avoiding the risk of side collision may be calculated. On the other hand, in a scene where no lane structure exists, the safety distance may be calculated to avoid the risk of collision of trajectory of the host vehicle 2 in a given direction.

The risk supervising block 140 may identify a scene-by-scene situation of relative motion between the host vehicle 2 and the target vehicle 3 prior to setting the safety envelope as described above. For example, in a scene where a lane structure such as lanes exists, a situation where the risk of rear-end collision and head-on collision is assumed in the longitudinal direction and a situation where the risk of side collision is assumed in the lateral direction may be identified. In identifying these longitudinal and lateral situations, the state quantity relating to the host vehicle 2 and the target moving body 3 may be transformed into a coordinate system that assumes a lane structure with straight lanes. On the other hand, in a scene where no lane structure exists, a situation where a risk of collision of trajectory in a direction of the host vehicle 2 may be identified. For the above-described situation identification function, the situation identification result may be given to the risk supervising block 140 as the detection information by executing at least part of the situation identification function.

The risk supervising block 140 executes a safety determination between the host vehicle 2 and the target moving body 3 based on the set safety envelope and the acquired detection information for each scene. That is, the risk supervising block 140 tests (i.e., judges) whether the driving scene interpreted based on the detection information between the host vehicle 2 and the target moving body 3 causes a safety envelope violation that is a violation of the safety envelope. When a safety distance is assumed in setting the safety envelope, no violation of the safety envelope may be determined to occur because the actual distance between the host vehicle 2 and the target moving body 3 exceeds the safety distance. On the contrary, when the actual distance between the host vehicle 2 and the target moving body 3 is reduced to be equal to or less than the safe distance, the safety envelope may be determined to be violated.

The risk supervising block 140 may calculate a reasonable scenario through simulation to provide the host vehicle 2 with an appropriate action to be taken in response to a determination that the safety envelope has been violated. In the reasonable scenario simulation, by estimating a state transition between the host vehicle 2 and the target moving body 3, an action to be taken for each transition state is set as a constraint/restriction (which will be described later) on the host vehicle 2. In setting the action, a restriction value assumed for a kinetic physical quantity may be calculated so as to limit, as a constraint/restriction on the host vehicle 2, at least one type of the kinetic physical quantity given to the host vehicle 2.

Based on the safety model for the host vehicle 2 and the target moving body 3 that are assumed to comply with the driving policy, the risk supervising block 140 may directly calculate the restriction value to comply with the accident liability rules from the profile relating to at least one type of the physical quantity. It may be said that the direct calculation of the restriction value is setting of the safety envelope and also said that it is setting of a constraint/restriction on the driving control. Therefore, if an actual value that is safer than the restriction value is detected, the safety envelope may be determined to be not violated. On the other hand, if an actual value outside of the restriction value is detected, the safety envelope may be determined to be violated.

The risk supervising block 140 may store, in the memory 10, at least one type of evidence information such as detection information used to set the safety envelope, determination information indicative of the determination result of the safety envelope, detection information having an effect on the determination result, and simulated scenarios. The memory 10 that stores the evidence information may be installed inside the host vehicle 2 or installed at an external center outside of the host vehicle 2 according to the type of the dedicated computer that constitutes the processing system 1. The evidence information may be stored unencrypted, encrypted or hashed. Storing the evidence information is performed at least when the safety envelope is determined to be violated. The evidence information may be stored even when the safety envelope is determined to be not violated. The evidence information when no violation of the safety envelope is determined to occur can be used as a lagging indicator at the time of memorization and also be used as a leading indicator in future.

The control block 160 acquires a control command from the planning block 120. The control block 160 acquires the determination information on the safety envelope from the risk supervising block 140. That is, the control block 160 implements a DDT function that controls the motion of the host vehicle 2. The control block 160 executes the planned driving control of the host vehicle 2 in accordance with the control command when the control block 160 acquires the determination information that the safety envelope is not violated.

On the other hand, when the control block 160 acquires the determination information indicating that the safety envelope is violated, the control block 160 imposes a restriction/constraint on the planned driving control of the host vehicle 2 according to the driving policy based on the determination information. The restriction/constraint on the driving control may be a functional restriction. The restriction/constraint on the driving control may be degraded constraints. The restriction/constraint on the driving control may be a restriction different from the above-described restrictions or constraints. The restriction/constraint on the driving control is given by a restriction on the control command. When a reasonable scenario has been simulated by the risk supervising block 140, the control block 160 may restrict the control command according to that scenario. At this time, when a restriction value is set for the kinetic physical quantity of the host vehicle 2, the control parameter of the motion actuator included in the control command may be corrected based on the restriction value.

Next, details of the first embodiment will be described below.

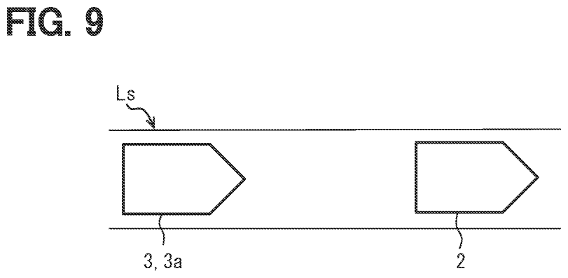

As shown in FIG. 9, the first embodiment assumes a lane structure Ls with a separated lane. The lane structure Ls with a direction in which the lane extends as the longitudinal direction imposes a restriction on the motion of the host vehicle 2 and the target moving body 3. The lane structure Ls with a width direction of the lane or a direction in which the lanes are arranged as the lateral direction imposes a restriction on the motion of the host vehicle 2 and the target moving body 3.

When the target moving body 3 is the target vehicle 3a, the driving policy between the host vehicle 2 and the target moving body 3 in the lane structure Ls is defined by the following (A) to (E), etc., for example. It should be noted that the forward direction with respect to the host vehicle 2 is, for example, a traveling direction on a turning circle at the current steering angle of the host vehicle 2, a traveling direction of a straight line along a line that passes through the center of gravity of the host vehicle 2 and is perpendicular to the axle of the host vehicle 2, or a traveling direction along an axial line of the FOE (Focus of Expansion) of the camera from the front camera module in the sensor system 5 of the host vehicle 2. (A) The vehicle will not collide with a preceding vehicle from behind. (B) The vehicle will not forcibly cut in between other vehicles. (C) Even if the vehicle has priority, the vehicle will give way to other vehicles depending on the situation. (D) The vehicle cautiously travels in a place with poor visibility. (E) Regardless of whether the vehicle has a responsibility or not, if it is possible for the vehicle to avoid an accident by itself, the vehicle will take a reasonable action to avoid it.

In the safety model that is in compliance with the driving policy and is formed by modeling SOTIF, the action by the road user which does not lead to an unreasonable situation is assumed to be a reasonable action that is to be taken by the road user. The unreasonable situation between the host vehicle 2 and the target moving body 3 in the lane structure Ls is a head-on collision, a rear-end collision, and a side collision. When the target moving body 3 for the host vehicle 2 is a target vehicle 3, the reasonable action in a head-on collision situation includes, for example, applying brakes to the vehicle traveling in the opposite direction. When the target moving body 3 for the host vehicle 2 is a target vehicle 3, the reasonable action in a rear-end collision situation includes, for example, not applying brakes suddenly with a certain level or more to the preceding vehicle and avoiding the rear-end collision by the following vehicle on the premise that the preceding vehicle would not slow suddenly. When the target moving body 3 for the host vehicle 2 is a target vehicle 3, the reasonable action in a side collision situation includes, for example, steering by each of the side vehicles traveling side by side in a direction away from each other. When assuming the reasonable action, the state quantities related to the host vehicle 2 and the target moving body 3 are converted into, regardless of whether the lane structure Ls has a curved lane or the lane structure Ls has an undulating lane, a Cartesian coordinate system defining the longitudinal direction and the transverse direction assuming a planar lane structure Ls that is extends linearly.

The safety model may be designed according to accident liability rules which assume that a moving body that does not take a reasonable action would be responsible for the accident. In the safety model used to monitor the risk between the host vehicle 2 and the target vehicle 3 under the accident liability rule in the lane structure Ls, a safety envelope is set for the host vehicle 2 so as to avoid a potential accident liability by taking a reasonable action. Therefore, when the entire processing system 1 is operating in a normal state, the risk supervising block 140 determines whether violation of the safety envelope occurs by comparing an actual distance between the host vehicle 2 and the target moving body 3 with the safety distance that is set based on the safety model for each driving scene. The risk supervising block 140 simulates a scenario to give the host vehicle 2 a reasonable action if violation of the safety envelope occurs. Based on the simulation, the risk supervising block 140 sets, as a restriction on the driving control by the control block 160, a restriction value regarding at least one of speed and acceleration, for example.

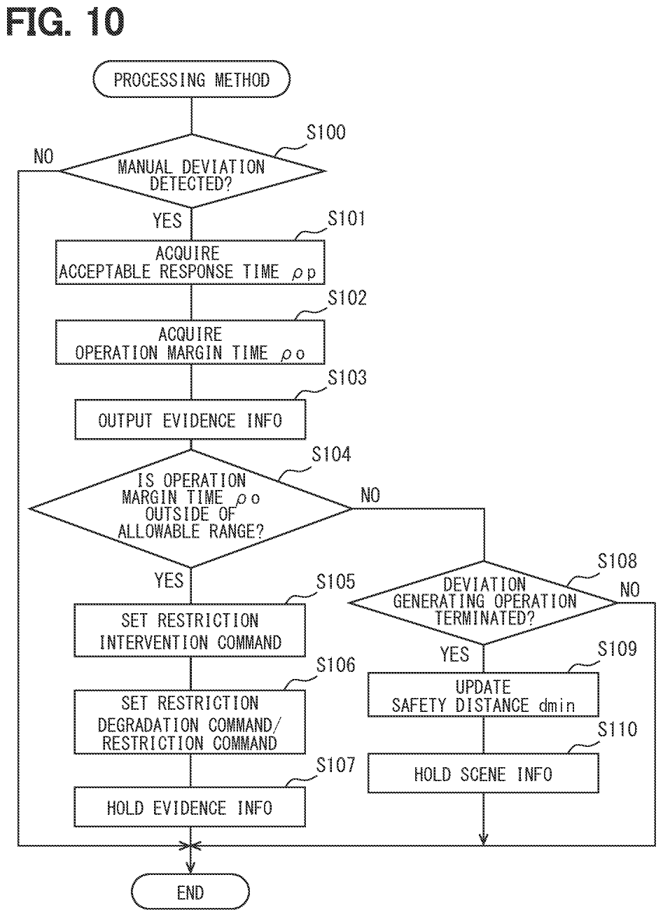

In the first embodiment, a processing method for performing the driving control according to the flowchart shown in FIG. 10 is executed by cooperation of multiple functional blocks. The processing method in the first embodiment is repeatedly performed during manual-driving planned by the planning block 120. In the following description, each “S” in the processing method means multiple steps executed by multiple instructions included in the processing program.

At S100 of the processing method, the risk supervising block 140 determines whether the sensing block 100 detected a manual deviation in which the driver's manual operation deviates from a driver's standard operation (or a driver's normal operation) in the manually-operated host vehicle 2. The manual deviation is detected by the sensing block 100 based on the operation data representing the operation state of the driver which is sensor data acquired from the internal sensor 52 such as an actuator sensor in the sensor system 5.

The risk supervising block 140 acquires normal information regarding the standard operation in determining whether the manual deviation is detected. The standard operation means an operation with a reasonable or minimal risk on the kinematic actuators controlled according to each scene in the automated-driving host vehicle 2. Therefore, the normal information may be acquired including a reasonable or minimal risk operation amount, and may also be acquired including a variance value (that is, an allowable error) of the operation amount. The risk supervising block 140 may acquire the normal information from the planning block 120 which plans a trajectory for the standard operation in the automated-driving. The risk supervising block 140 may acquire the normal information by calculation such as simulation based on a kinetic physical quantity profile assumed according to a safety model for the automated-driving.

In determining whether the manual deviation is detected, the risk supervising block 140 acquires detection information regarding a deviation generating operation, which is the manual operation by the driver that generates the manual deviation. The detection information is generated by the sensing block 100 based on operation data. The deviation generating operation may be an additional manual operation for risk avoidance, which is manually performed by the driver psychologically or sensorily against the risk in each scene so as to deviate from the standard operation under the advanced driving assistance control. The deviation generating operation may be a manual operation that deviates from the standard operation by manually performed by the driver at each scene during manual-driving without intervention by the automated-driving. The deviation generating operation may be, for example, a fine adjustment operation (that is, steering correction) including additionally turning or turning back of the steering wheel with respect to the standard operation of the steering according to, for example, the curvature of a curved road. The deviation generating operation may be, for example, a braking-on operation as opposed to a braking-off standard operation in a straight road or a curved road. The deviation generating operation may be, for example, an accelerator-off operation as opposed to an accelerator-on standard operation at the exit of a straight road or a curved road. The detection information is acquired with an operation amount by the driver to the motion actuator by during the manual-driving to represent such a deviation generating operation.

The risk supervising block 140 at S100 determines whether the manual deviation is detected based on whether the difference between the operation amount representing the normal information and the operation amount representing the detection information exceeds a set range. The set range for determining the detection may be set less than the lower limit of the difference with which the manual deviation is determined to generate and equal to more than the upper limit of the difference which is determined to fall within the range of the standard operation. When the normal information includes the variance value of the operation amount, the set range of the difference may be set to be equal to or less than the upper limit which is the operation amount plus the variance value on a safer side.

When the difference between the operation amounts is within the set range at S100, the current flow of the processing method ends by the risk supervising block 140 determining that no manual deviation is detected. On the contrary, when the difference between the operation amounts is outside of the set range at S100, the process proceeds to S101 by the risk supervising block 140 determining that the manual deviation is detected.

At S101, the risk supervising block 140 acquires an acceptable response time ρp that is a response time p for the host vehicle 2 with respect to the target moving body 3 based on the safety model that is in compliance with the driving policy and is formed by modeling the SOTIF. The response time p when generating the manual deviation at the host vehicle 2 means a time required for the host vehicle 2 to react to the deviation generating operation by the driver including the driver's response time.

The response time ρ of the host vehicle 2 correlates with the safety distance dmin which determines the restriction/constraint on the driving control of the host vehicle 2 in the safety model. That is, the response time ρ of the host vehicle 2 is used as a variable in a safety function L representing the kinematic physical quantity profile for calculating the safety distance dmin according to Equation (1). Q in Equation 1 is at least one type of the kinetic physical quantity used for the motion profile. As the kinetic physical quantity Q, for example, velocity, acceleration/deceleration, azimuth angle, azimuth angular velocity, positional deviation amount, etc. regarding at least one of the host vehicle 2 and the target moving body 3 are selected according to each scenario or scene assumed in the safety model.

d min=L(ρ,Q) [Equation 1]

The inverse function R in the safety function L is defined by a functional expression or algorithm that satisfies Equation 2 according to the safety model between the host vehicle 2 and the target moving body 3. dr in Equation 2 is an actual distance to be compared with the safety distance dmin in determining whether the safety envelope is violated, that is, a distance between the host vehicle 2 and the target moving body 3 at the time of executing S101. Accordingly, the risk supervising block 140 at S101 calculates the acceptable response time ρp of the host vehicle 2 by following Equation 3 using the inverse function R. After completing the execution of S101, the process proceeds to S102.

dr≥L(R(dr,Q),Q) [Equation 2]

ρp=R(dr,Q) [Equation 3]

At S102 of the processing method, the risk supervising block 140 acquires an operation margin time ρo to be given to the driver's manual operation in the host vehicle 2 based on the acceptable response time ρp of the host vehicle 2 acquired at S101. The operation margin time ρo can also be referred to as a margin time that is allowed for the driver's deviation generating operation in the host vehicle 2 according to the safety model between the host vehicle 2 and the target moving body 3. The operation margin time ρo is calculated by following Equation 4 using the acceptable response time ρp. In Equation 4, ρv is a minimum time necessary for the host vehicle 2 to take an action to avoid an unreasonable risk under an unreasonable situation, and is defined as an action required time. The action required time ρv is set as a time expected to be required for avoiding a risk depending on each scenario or scene after intervention by the automated-driving to the manual-driving occurred. After completing the execution of S102, the process proceeds to S103.

ρo=ρp−ρv [Equation 4]

At S103 of the processing method, the risk supervising block 140 outputs, to the memory 10, the evidence information including at least one of the acceptable response time ρp acquired at S101 and the operation margin time ρo acquired at S102. The evidence information is stored in the memory 10 with at least one of the output time ρp and the output time ρo in association with time stamps each representing a generating time for each calculation target scene. The evidence information includes at least one of, for example, a calculation variable of the acceptable response time ρp including the kinetic physical quantity Q, a calculation variable of the operation margin time ρo including the action required time ρv, detection information for identifying the target moving body 3, and detection information including the action of the target moving body 3. Outputting the evidence information may be performed at each cycle of the processing method according to the controlling period. Outputting the evidence information at S103 may be performed at a set cycle longer than one cycle of the processing method or at every multiple cycles of the processing method for the purpose of, for example, eliminating noise information. In the case of outputting every set period or every multiple cycles, S103 is skipped at the timing of non-outputting.

At S103, the evidence information may be stored by being output to the memory 10 in the host vehicle 2 or may be stored by being remotely distributed to the memory 10 of an external center outside of the host vehicle 2. The in-vehicle memory 10 to which the evidence information is output may be mechanically protected even if the host vehicle 2 crashes. The in-vehicle memory 10 to which the evidence information is output may be protected at a fireproof area. The in-vehicle memory 10 to which the evidence information is output may be protected at a waterproof area. The protected memory 10 protected within the host vehicle 2 may store encrypted or hashed evidence information. In the case of encrypted evidence information, a decryption key may be stored in at least one of a protected memory 10 within the host vehicle 2, an unprotected memory 10 within the host vehicle 2, an external center memory 10 outside of the host vehicle 2, and the like. In the case of hashed evidence information, transactions with hashed values may be stored in at least one of a protected memory 10 within the host vehicle 2, an unprotected memory 10 within the host vehicle 2, an external center memory 10 outside of the host vehicle 2, and the like. After completing the execution of S103, the process proceeds to S104.

At S104 of the processing method, the risk supervising block 140 determines whether the operation margin time ρo acquired at S102 is outside of the allowable range. The allowable range, which is a criterion for the operation margin time ρo, may be set to a value more than the upper limit of the time ρo that is determined to be required for risk avoidance such as DDT fallback or degradation. The allowable range may be also set to a value equal to or more than the lower limit of the time ρo that is determined to be not required for the risk avoidance. The allowable range of the operation margin time ρo may be set to a range beyond the assumed upper limit larger than 0. In this case, the range outside of the set range means a range equal to or less than the upper limit and on a positive side or a negative side across 0. The allowable range of the operation margin time ρo may be set to a range beyond 0 which is assumed as the upper limit. In this case, the range outside of the set range means a range on a negative side of 0 (i.e., equal to or less than 0).

When the risk supervising block 140 determines at S104 that the operation margin time ρo is outside of the allowable range, the processing method proceeds to S105. On the contrary, when the risk supervising block 140 determines at S104 that the operation margin time ρo is within the allowable range, the processing method proceeds to S108.

At S105 of the processing method, the risk supervising block 140 sets a restriction on the driving control of the host vehicle 2 to allow the automated-driving to intervene in the manual-driving of the host vehicle 2. The restriction (or the constraint) for the intervention may be an intervention command to control block 160. In this case, even during manual-driving, the control command for automated-driving is given from the planning block 120 to the control block 160 together with the control command for the manual-driving. Thus, the control command may be selected at the control block 160 depending on the intervention command. After completing the execution of S105, the process proceeds to S106.

At S106 of the processing method, the risk supervising block 140 sets a restriction on the driving control of the host vehicle 2 to avoid an unreasonable risk against the host vehicle 2 in the automated-driving. The acceptable response time for avoiding the risk is a degradation command to the control block 160 to continue the operation control in automated-driving by executing a degraded traveling such as emergency evacuation action or MRM with best effort for the host vehicle 2. The restriction for avoiding the risk may be a restriction command, as a restriction for shifting the host vehicle 2 in automated-driving to the minimum risk state based on the safety model, to the control block 160 based on determination information that the safety envelope is violated. If the restriction command is given as a restriction, the determination of whether the operation time margin ρo is outside of the allowable range may be used as the determination of whether the safety envelope is violated.

At S106, for the operation margin time ρo on a positive side greater than 0 in a range outside of the allowable range when the allowable range of the operation margin time ρo exceeds the upper limit greater than 0, a degradation command may be switched as a restriction. Similarly, for the operation margin time ρo equal to or less than 0, a restriction command may be switched as a restriction. By such switching, when the operation margin time ρo on a positive side is eliminated, the restriction command may be set as a restriction on a safer side that is stricter than the degradation command that is set when the operation margin time ρo is left on the positive side. After completing the execution of S106, the process proceeds to S107.

At S107 of the processing method, the risk supervising block 140 holds (that is, accumulates), in the memory 10, the evidence information output at S103 including at least one of the acceptable response time ρp and the operation margin time ρo. The memory 10 that holds the evidence information may be the same as or different from the memory 10 in which the evidence information is stored at S103. If the memories 10 are different from each other, the evidence information may be held after changing the storage destination to the memory 10 mounted in the host vehicle 2 or may be held after changing the storage destination to the memory 10 of the external center outside of the host vehicle 2. If the memories 10 are different from each other, the interval from storing at S103 (i.e., temporary storage) to holding by changing the storage destination at S107 (i.e., secondary storage) is set shorter than the storage interval described above regarding S103. By doing so, even if the host vehicle 2 is powered off, it is possible to reliably hold the evidence information.

At S107, the memory 10 by which the evidence information is held may be mechanically protected even if the host vehicle 2 crashes. The memory 10 by which the evidence information is held may be protected in a fireproof area. The memory 10 by which the evidence information is held may be protected in a waterproof area. The protected memory 10 protected within the host vehicle 2 may hold encrypted or hashed evidence information. In the case of encrypted evidence information, a decryption key may be held, before or after change of the storage destination, in at least one of a protected memory 10 within the host vehicle 2, an unprotected memory 10 within the host vehicle 2, an external center memory 10 outside of the host vehicle 2, and the like. In the case of hashed evidence information, transactions with hashed values may be held in at least one of a protected memory 10 within the host vehicle 2, an unprotected memory 10 within the host vehicle 2, an external center memory 10 outside of the host vehicle 2, and the like.

By executing S107 in this way, it is possible to store, as evidence information, the driver's operation behavior history in a scenario or scene that leaded to an unreasonable situation or an unreasonable risk state. After the execution of S107 is completed, the current flow of the processing method ends. In executing S107, in addition to holding the evidence information, a temporal change in the operation margin time ρo may be observed based on the evidence information stored in the memory 10 while the manual deviation is generating. In this case, the driver state such as fatigue level may be determined based on the change over time, and the determination result may be utilized for planning or executing the driving control or for determining whether the safety envelope is violated.

As shown in FIG. 10, at S108 of the processing method, when the operation margin time ρo is within the allowable range, the risk supervising block 140 determines whether the deviation generating operation by the driver in the host vehicle 2 is terminated, in other words, determines whether the sensing block 100 detected termination of the deviation generating operation. Therefore, the determination of the termination of the deviation generating operation is based on the detection information in the sensing block 100 according to S100. If the risk supervising block 140 determines at S108 that the deviation generating operation continues, the current flow of the processing method ends. On the other hand, if the risk supervising block 140 determines at S108 that the deviation generating operation ended, the processing method proceeds to S109.

That is, S109 of the processing method is executed when the deviation generating operation is determined to end with the operation margin time ρo within the allowable range. At S109, the risk supervising block 140 updates the safety distance dmin assumed in the safety model based on the operation margin time ρo output at S103. Here, the safety distance dmin is calculated by the safety function L of Equation 1 as a distance to be secured between the host vehicle 2 and the target moving body 3 during the automated-driving according to the safety model. Updating the safety distance dmin may be performed by the risk supervising block 140 adjusting or learning parameter coefficients of the safety function L. After completing the execution of S109, the process proceeds to S110.

At S110 of the processing method, the risk supervising block 140 stores and holds in the memory 10 scene information representing an end scene of the deviation generating operation. The scene information can also be said to be event information representing an end event of the deviation generating operation. The scene information is stored and hold in association with a time stamp representing the end time of the deviation generating operation. Storing and holding the scene information may be performed similar to storing and holding the evidence information as described above. By executing S110 as described above, the driver's operation behavior history in a scenario or scene in which risk was avoided without intervention by automated-driving can be stored as the evidence information different from at least one of the acceptable response time ρp and the operation margin time ρo, After the execution of S110 is completed, the current flow of the processing method ends.

Upon completion of execution of S108 and S110, the risk supervising block 140 may delete the evidence information including at least one of the allowable reaction time ρp and the operation margin time ρo stored at S103. Upon completion of execution of S108 and S110, the risk supervising block 140 may hold the evidence information stored at S103 in the memory 10 according to S107. The risk supervising block 140 may overwrite the evidence information that was currently stored at S103 with new evidence information that will be stored at S103 in the next flow after completion of S108 or S110.

As described above, the technology disclosed in JP 6,708,793 B assumes a response time for the host vehicle during automated-driving. However, during manual-driving, the reaction time differs from that during automated-driving due to, for example, the characteristic of the driver's operation. Therefore, even if the technology disclosed in JP 6,709,893 B is applied to the manual-driving, it may be difficult for the host vehicle to ensure the accuracy of driving control with an appropriate safety restriction. Further, as described above, the technology disclosed in JP 6,708,793 B assumes a common reaction time for the host vehicle and the target vehicle. However, the reaction time of the target vehicle following the host vehicle differs from that of the host vehicle, depending on whether the target vehicle is driven automatically or manually, or depending on the vehicle type of the target vehicle. Therefore, when the target vehicle is following the host vehicle, it may be difficult for the host vehicle to ensure the accuracy of driving control by the appropriate safety restriction during automated-driving.

In contrast, according to the first embodiment described above, when the manual deviation, which is a deviation of the manual operation by the driver from the standard operation, is generating, the allowable reaction time ρp is acquired based on the safety model that is a model in accordance with the driving policy and is formed by modeling SOTIF and the acquired allowable reaction time ρp is output. Accordingly, it is possible to assume an allowable reaction time ρp that is specific to a scene in which the manual deviation generates, and thus the accuracy of the driving control can be secured by setting an appropriate restriction (or constraint) on the host vehicle 2 in the manual-driving.

### Second Embodiment

A second embodiment is a modification to the first embodiment.

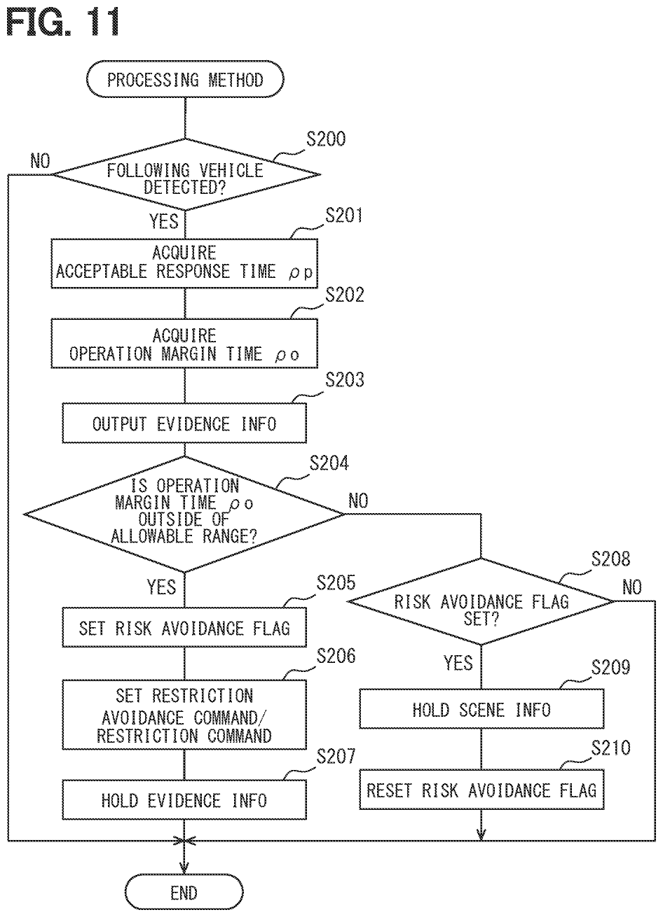

As shown in FIG. 11, at S200 of the processing method according to the second embodiment, the risk supervising block 140 determines whether the target vehicle 3a (hereinafter, referred to as a “following vehicle”) as a target moving body 3 that is traveling behind the host vehicle 2 in automated-driving is detected by the sensing block 100. Detecting the following vehicle 3a by the sensing block 100 is performed based on data acquired from at least one of the external sensor 50 of the sensor system 5 and the V2X type communication system 6. In determining whether the following vehicle 3a is detected, the risk supervising block 140 acquires detection information including information about the following vehicle 3a.

If the risk supervising block 140 determines at S200 that the following vehicle 3a is not detected, the current process of the processing method ends. On the other hand, when the risk supervising block 140 determines at S200 that the following vehicle 3a is detected, the processing method proceeds to S201.

At S201, the risk supervising block 140 acquires an acceptable response time ρp that is a response time ρ for the following vehicle 3a with respect to the host vehicle 2 based on the safety model that is in compliance with the driving policy and is formed by modeling the SOTIF. The reaction time ρ of the following vehicle 3a during automated-driving or manual-driving means the time required for the following vehicle 3a to react including the response time by the driver.

The reaction time ρ of the following vehicle 3a is used as a variable in the safety function L of Equation 1 according to S101, and an inverse function R of the safety function L is defined by a function or an algorithm that satisfies Equation 2 according to S101. However, dr in Equation 2 is an actual distance to be compared with the safety distance dmin in determining whether the safety envelope is violated, that is, a distance between the host vehicle 2 and the following vehicle 3a at the time of executing S201. Based on these facts, the risk supervising block 140 at S201 presumptively calculates the allowable reaction time ρp of the following vehicle 3a by following Equation 3 according to S101.

The risk supervising block 140 shown in FIG. 8 simulates a reasonable scenario between the host vehicle 2 and the following vehicle 3a in automated-driving, and manages the state of the scenario and switching of the scenario. By performing such scenario management, the risk supervising block 140 maintains the state of the reasonable scenario between the host vehicle 2 and the following vehicle 3a. In addition, the risk supervising block 140 determines, for each state transitions of the held scenario, a reasonable behavior which is an appropriate response by each of the host vehicle 2 and the following vehicle 3a.

Therefore, at S201 shown in FIG. 11, the risk supervising block 140 manages the period of interest between the start scene and the end scene that are synchronized with the state transition of the scenario regarding the reasonable behavior of interest in calculating the allowable reaction time ρp. As a start scene of the reasonable behavior of interest, for example, an event that needs to be avoided with respect to an accident risk with high importance, such as a collision risk by the following vehicle 3a when the host vehicle 2 is stopped at a traffic light, may be specified. Either a termination event of a reasonable scenario or an occurrence event of a violation of the safety envelope may be specified as the termination scene of the reasonable behavior of interest. Based on these facts, the risk supervising block 140 may calculate the allowable reaction time ρp according to Equation 3 for the period of interest for the reasonable behavior. After completing the execution of S201, the process proceeds to S202.

At S202 of the processing method, the risk supervising block 140 acquires an operation margin time ρo to be given to an automated-operation by the automated-driving in the host vehicle 2 based on the acceptable response time ρp of the following vehicle 3a acquired at S202. The operation margin time ρo can also be referred to as a margin time for a risk avoidance operation according to the safety model between the host vehicle 2 and the following vehicle 3a. The risk supervising block 140 calculates the operation margin time ρo of the host vehicle 2 with respect to the following vehicle 3a by following Equation 4 according to S102. However, the behavior required time ρv is set to the time that is expected to be required for avoiding a risk according to each scenario or scene after an unreasonable situation or an unreasonable risk state occurred. After completing the execution of S202, the process proceeds to S203.

At S203 of the processing method, the risk supervising block 140 outputs, to the memory 10 according to S103, the evidence information including at least one of the acceptable response time ρp acquired at S201 and the operation margin time ρo acquired at S202. However, at S203, the evidence information may include scene information representing at least one of the start scene and the end scene of the reasonable behavior of interest. The operation margin time ρo stored in the memory 10 at S203 may be used to update the safety distance dmin assumed in the safety model according to S109. After completing the execution of S203, the process proceeds to S204.

At S204 of the processing method, the risk supervising block 140 determines, according to S104, whether the operation margin time ρo acquired at S202 is outside of the allowable range. When the risk supervising block 140 determines at S204 that the operation margin time ρo is outside of the allowable range, the processing method proceeds to S205. On the contrary, when the risk supervising block 140 determines at S204 that the operation margin time ρo is within the allowable range, the processing method proceeds to S208.

At S205 of the processing method, the risk supervising block 140 sets, in the memory 10, a risk avoidance flag indicating that a risk avoidance operation is being performed. The risk avoidance operation is an automated-operation to impose a restriction on the driving control of the host vehicle 2. After completing the execution of S205, the process proceeds to S206.

At S206 of the processing method, the risk supervising block 140 sets a restriction on the driving control of the host vehicle 2 in the automated-driving to avoid an unreasonable risk against the following vehicle 3a. The restriction for avoiding a risk may be an avoidance command to avoid collision of the following vehicle 3a as much as possible by best effort for the host vehicle 2 by, for example, early deceleration or deceleration reduction. The restriction for avoiding the risk is a restriction command to the control block 160 based on determination information that the safety envelope is violated as a restriction for shifting the host vehicle 2 in automated-driving to the minimum risk state based on the safety model. If the restriction command is given as a restriction, the determination of whether the operation time margin ρo is outside of the allowable range may be used as the determination of whether the safety envelope is violated.

At S206, for the operation margin time ρo on a positive side greater than 0 in a range outside of the allowable range when the allowable range of the operation margin time ρo exceeds the upper limit greater than 0, an avoidance command may be selected as a restriction. Similarly, for the operation margin time ρo equal to or less than 0, a restriction command may be selected as a restriction. By such switching, when the operation margin time ρo on a positive side is eliminated, the restriction command may be set as a restriction on a safer side that is stricter than the avoidance command that is set when the operation margin time ρo is left on the positive side. After completing the execution of S206, the process proceeds to S207.

At S207 of the processing method, the risk supervising block 140 holds (that is, accumulates), in the memory 10 according to S107, the evidence information including at least one of the acceptable response time ρp and the operation margin time ρo. However, the evidence information held at S207 may include scene information representing at least one of the start scene of the reasonable behavior of interest, the end scene of the reasonable behavior of interest, and the start scene of the risk avoidance operation. The evidence information held at S207 may include, for example, brake lamp lighting information as detection information representing the behavior of the following vehicle 3a with respect to the risk avoidance operation by the host vehicle 2. By executing S207 in this way, it is possible to store, as evidence information, the operation behavior history of the vehicles 2, 3a in a scenario or scene that leaded to an unreasonable situation or an unreasonable risk state. After completing the execution of S207, the process proceeds to S208.

As shown in FIG. 11, the risk supervising block 140 determines whether the risk avoidance flag is set in the memory 10 at S208 of the processing method when the operation margin time ρo is within the allowable range. If the risk supervising block 140 determines, at S208, that the risk avoidance flag is not set, the current flow of the processing method ends. On the contrary, if the risk supervising block 140 determines, at S208, that the risk avoidance flag is set, the processing method proceeds to S209.

That is, S209 of the processing method is executed when it is determined that the operation margin time ρo that was been outside of the allowable range is returned to be within the allowable range by the risk avoidance operation. At S209, the risk supervising block 140 stores and holds, in the memory 10, scene information representing the end scene of the risk avoidance operation as the evidence information different from at least one of the allowable reaction time ρp and the operation margin time ρo. By executing S209 as described above, the operation behavior history of the vehicles 2, 3a when recovering from a scenario or scene leading to an unreasonable situation or an unreasonable risk state can be stored as evidence information that is different from at least one of the allowable reaction time ρp and the operation margin time ρo. After completing the execution of S209, the process proceeds to S210.

At S210 of the processing method, the risk supervising block 140 clears the risk avoidance flag in the memory 10. After the execution of S210 is completed, the current flow of the processing method ends.

When the risk avoidance flag is not set and when execution of S208 and S210 is completed, the risk supervising block 140 may delete the evidence information including at least one of the allowable reaction time ρp and the operation margin time ρo stored at S103. When the risk avoidance flag is not set and when execution of S208 and S210 is completed, the risk supervising block 140 may hold the evidence information stored at S103 in the memory 10 according to S107, S207. The risk supervising block 140 may overwrite the evidence information that is currently stored at S103 with new evidence information that will be stored at S103 in the next flow after completion of S208 without setting of the risk avoidance flag or S210 of the current flow.

According to the second embodiment described above, the acceptable response time ρp for the following vehicle 3a as the target moving body 3 is acquired based on the safety model which is in accordance with the driving policy and is formed by modeling SOTIF when the following vehicle 3a is following the host vehicle 2 in the automated-driving. Then, the acquired acceptable response time is output. Accordingly, it is possible to assume an allowable reaction time ρp that is specific to a vehicle following scene in which the following vehicle 3a is following the host vehicle, and thus the accuracy of the driving control can be secured by setting an appropriate restriction (or constraint) on the host vehicle 2 in the manual-driving.

### Third Embodiment

A third embodiment is a modification to the first embodiment.

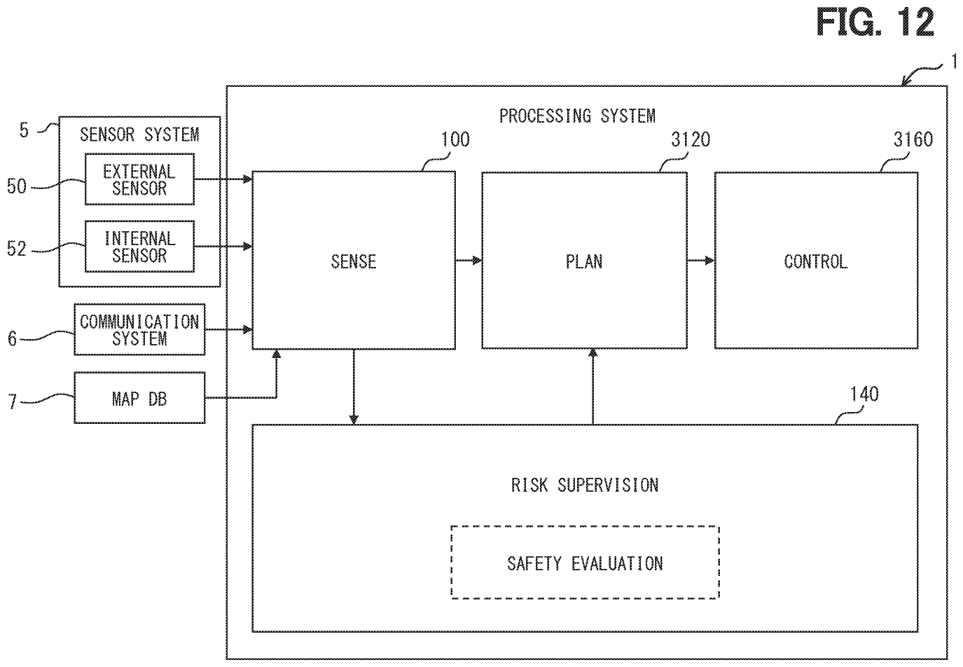

As shown in FIG. 12, in the control block 3160 according to the third embodiment, the acquisition processing of determination information regarding the safety envelope from the risk supervising block 140 is omitted. The planning block 3120 according to the third embodiment acquires determination information on the safety envelope from the risk supervising block 140. The planning block 3120 plans the driving control of the host vehicle 2 as with the planning block 120 when the determination information that the safety envelope is not violated is acquired. On the contrary, when the determination information indicating that the safety envelope is violated is acquired, the planning block 3120 imposes a restriction on the driving control based on the determination information at the stage of planning the driving control as with the planning block 120. That is, the planning block 3120 imposes a restriction on the planned driving control. In either case, the control block 3160 performs the driving control of the host vehicle 2 planned by the planning block 3120.

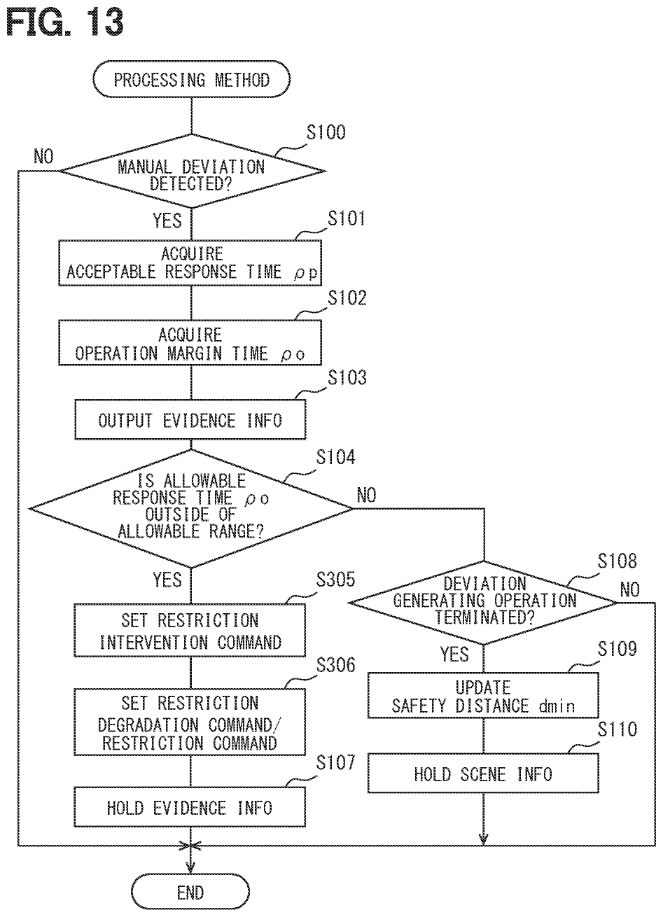

As shown in FIG. 13, at S305 of the processing method according to the third embodiment, the risk supervising block 140 executes a process according to S105 except that a restriction to intervene in the manual-driving by the automated-driving is performed by an intervention command to the planning block 3120. At S306 of the processing method according to the third embodiment, the risk supervising block 140 executes a process according to S106 except that setting a restriction to avoid a risk is performed by a degradation command or a restriction command to the planning block 3120. In such a third embodiment, it is possible to set an appropriate restriction on the manually operated host vehicle 2 and ensure the accuracy of the driving control based on the principle equivalent to the first embodiment.

### Fourth Embodiment

The fourth embodiment is a modification of the processing method in which the system configuration of the third embodiment is applied to the second embodiment.

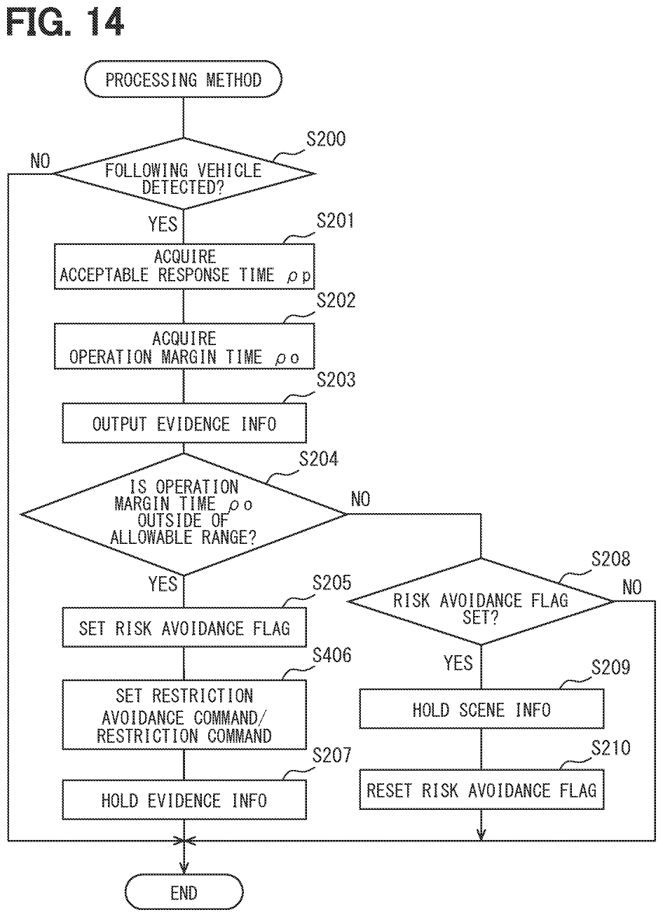

As shown in FIG. 14, at S406 of the processing method according to the fourth embodiment, the risk supervising block 140 executes a process equivalent to S206 except that setting a restriction to avoid a risk is performed by a avoidance command or a restriction command to the planning block 3120. In such a fourth embodiment, it is possible to set an appropriate restriction on the host vehicle 2 in the automated-driving and ensure the accuracy of the driving control based on the principle equivalent to the second embodiment.

### Fifth Embodiment

A fifth embodiment is a modification to the first embodiment.

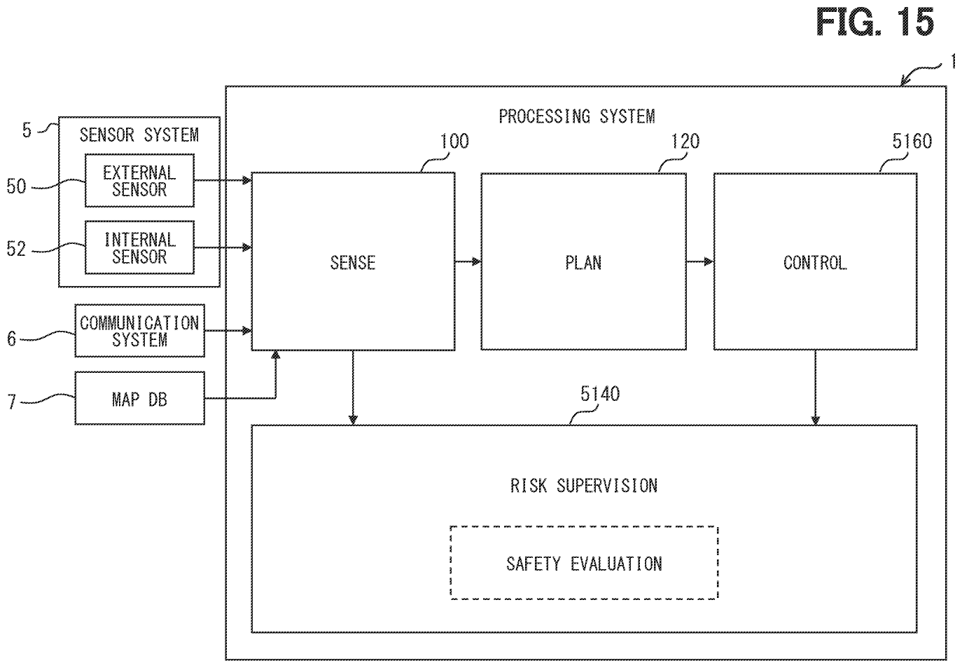

As shown in FIG. 15, in the control block 5160 according to the fifth embodiment, the acquisition processing of determination information regarding the safety envelope from the risk supervising block 5140 is omitted. Therefore, the risk supervising block 5140 of the fifth embodiment acquires information representing the result of the driving control executed by the control block 5160 for the host vehicle 2. The risk supervising block 5140 evaluates the driving control by performing, based on the safety envelope, safety determination on the results of the driving control.

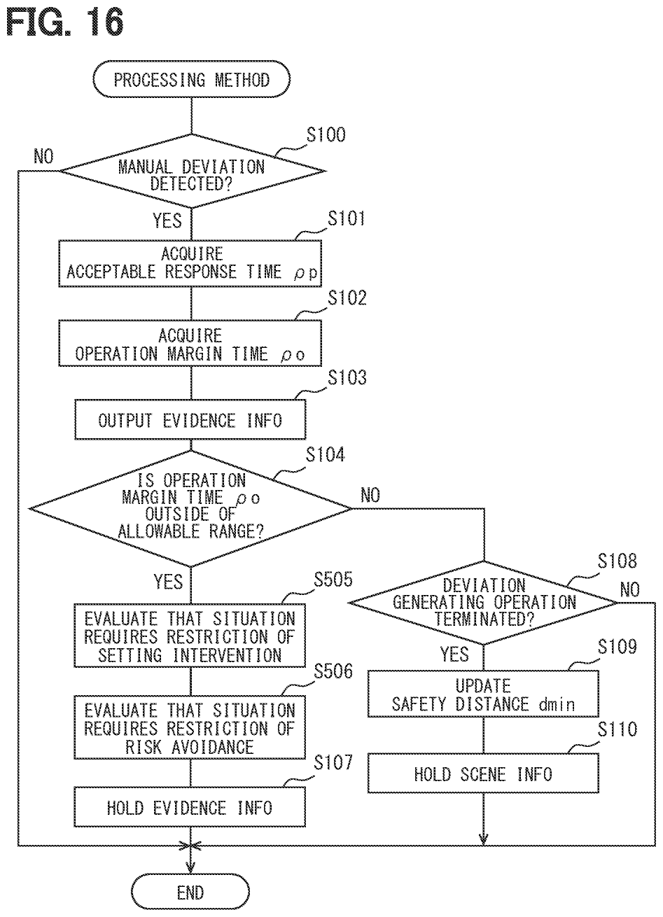

As shown in FIG. 16, at S505 of the processing method according to the fifth embodiment, the risk supervising block 5140 executes a process equivalent to S105 except that the block 5140 evaluates that the situation requires a restriction that is set to intervene in the manual-driving by the automated-driving. At S506 of the processing method according to the fifth embodiment, the risk supervising block 5140 executes a process equivalent to S106 except that the block 5140 evaluates that the situation requires a restriction that is set to avoid a risk. In such a fifth embodiment, it is possible to ensure the accuracy of the driving control based on the principle equivalent to the first embodiment by evaluating the driving control based on the restriction that is appropriately set on the host vehicle 2 in the manual-driving.

### Sixth Embodiment

The sixth embodiment is a modification of the processing method in which the system configuration of the fifth embodiment is applied to the second embodiment.

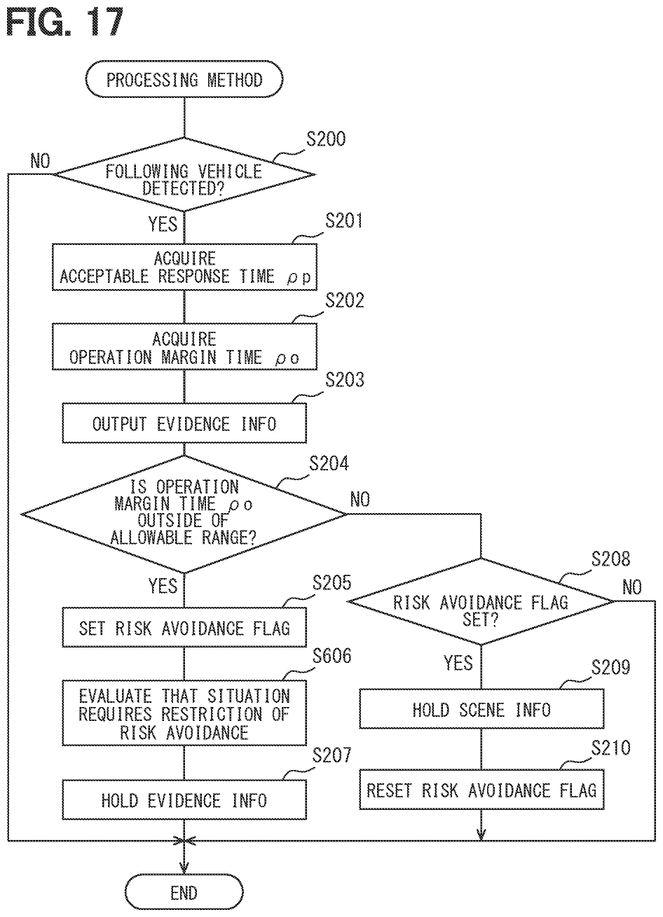

As shown in FIG. 17, at S606 of the processing method according to the sixth embodiment, the risk supervising block 5140 executes a process equivalent to S206 except that the block 5140 evaluates that the situation requires a restriction that is set to avoid a risk. In such a sixth embodiment, it is possible to ensure the accuracy of the driving control based on the principle equivalent to the second embodiment by evaluating the driving control based on the restriction that is appropriately set on the host vehicle 2 in the automated-driving.

### Seventh Embodiment

A seventh embodiment is a modification to the fifth or sixth embodiment.

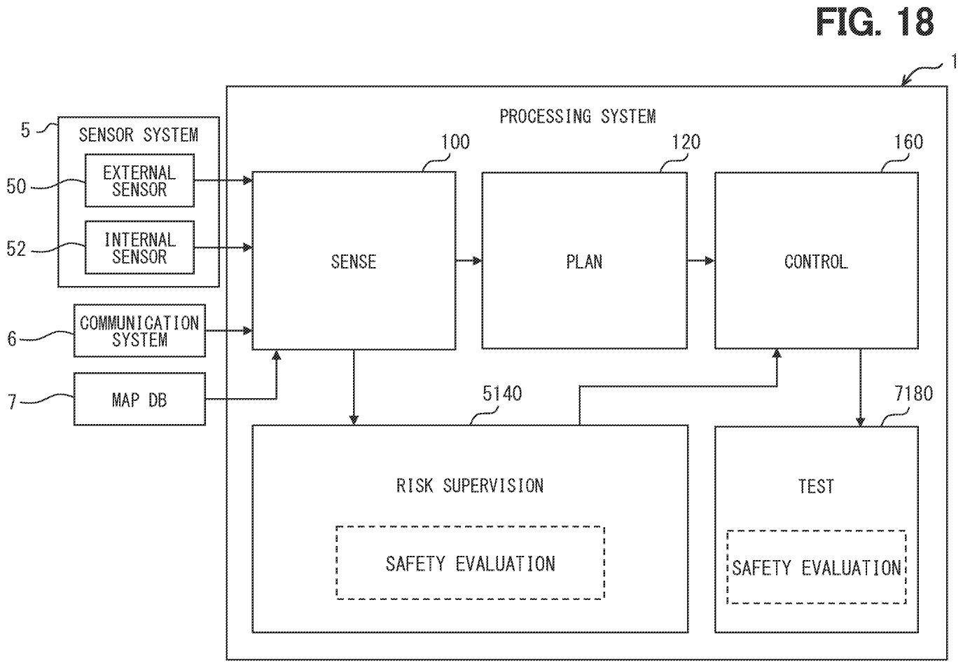

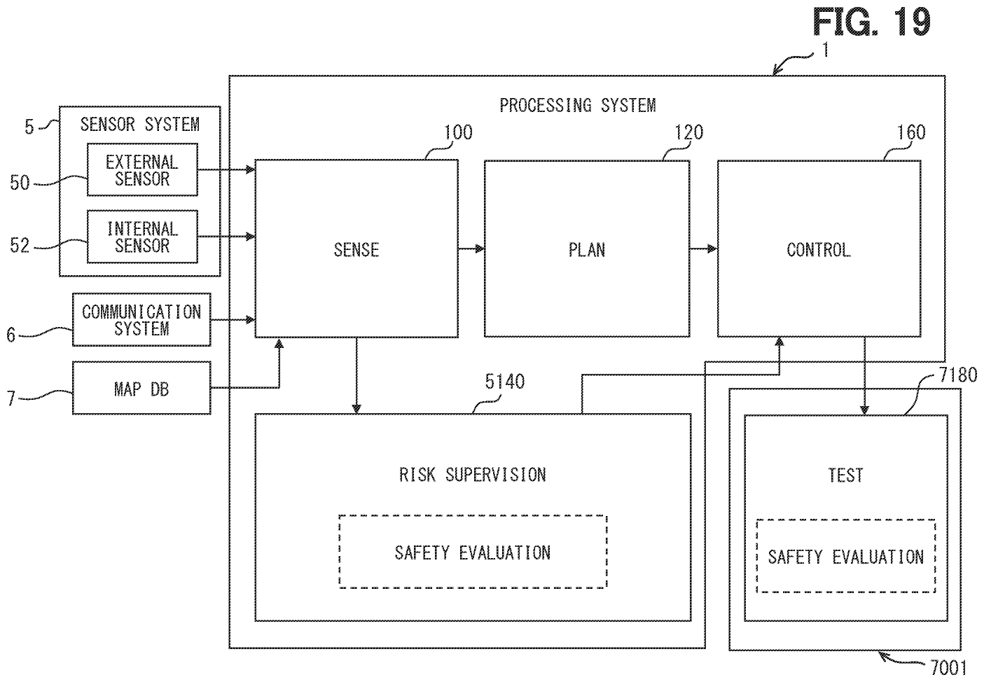

As shown in FIGS. 18 and 19, in the system configuration according to the seventh embodiment, a test block 7180 is added to test the driving control by the control block 160, e.g., for safety verification. The test block 7180 is provided with functionality similar to the sensing block 100 and the risk supervising block 5140. The test block 7180 may be realized by the processing system 1 shown in FIG. 18 executing a test program that is added to the processing program that provides the blocks 100, 120, 5140, 160. The test block 7180 may be realized by a test processing system 7001 that is different from the processing system 1 and is shown in FIG. 19 executing a program for testing that is different from the processing program that provides the blocks 100, 120, 5140, 160. Here, the test processing system 7001 may be a dedicated computer that has at least one memory 10 and processor 12 and is connected to the processing system 1 to test the driving control (not shown in the case of connection through the communication system 6).

In the processing method according to the seventh embodiment, the test block 7180 performs each step of the processing method according to the fifth or sixth embodiment instead of, or in addition to, performing by the risk supervising block 5140. However, FIGS. 18 and 19 omit illustration of the route through which the test block 7180 acquires detection information. In such a seventh embodiment, it is possible to ensure the accuracy of the driving control of the host vehicle 2 in the manual-driving by the principle equivalent to the first embodiment and of the host vehicle 2 in the automated-driving by the principle equivalent to the second embodiment by evaluating the driving control based on the restriction that is appropriately set on the host vehicle 2 in the automated-driving.

### Eighth Embodiment

A eighth embodiment is a modification to the third embodiment.

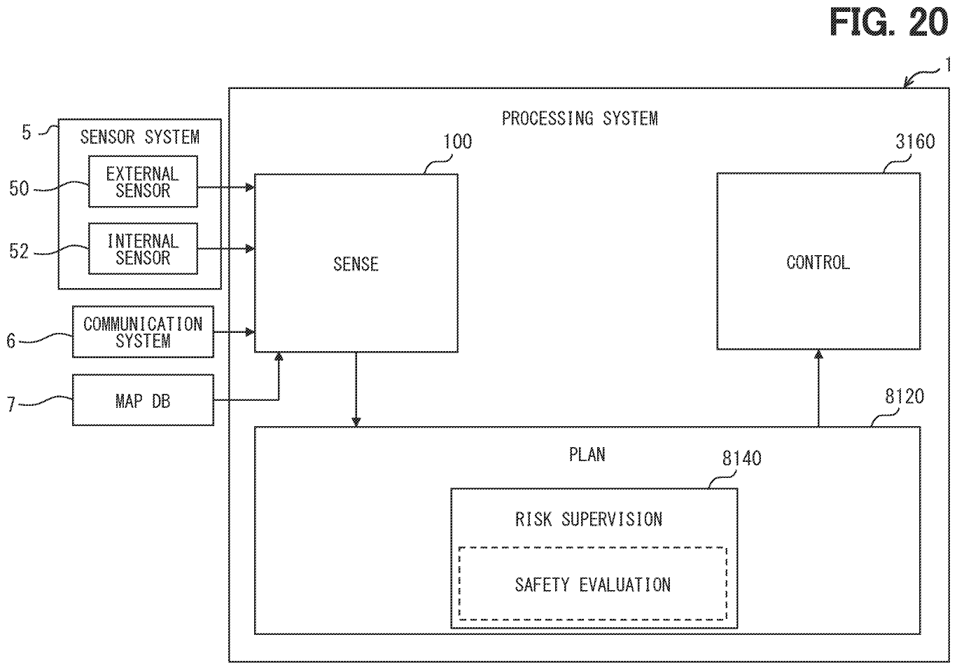

As shown in FIG. 20, the planning block 8120 according to the eighth embodiment incorporates the function of the risk supervising block 140 as a risk monitoring sub-block 8140. The planning block 8120 according to the eighth embodiment plans the driving control of the host vehicle 2 according to the planning block 120 when the determination information that the safety envelope is not violated is acquired by the risk monitoring sub-block 8140. On the contrary, when the determination information indicating that the safety envelope is violated is acquired by the risk monitoring sub-block 8140, the planning block 8120 imposes a restriction on the driving control based on the determination information at the stage of planning the driving control as with the planning block 120. That is, the planning block 8120 imposes a restriction on the planned driving control. In either case, the control block 3160 performs the driving control of the host vehicle 2 planned by the planning block 8120.

As shown in FIG. 23, at S805 of the processing method according to the eighth embodiment, the risk monitoring sub-block 8140 executes a process equivalent to the process at S105 described in the first embodiment except that a restriction to intervene in the manual-driving by the automated-driving is performed by an intervention plan at the planning block 8120. At S806 of the processing method according to the eighth embodiment, the risk monitoring sub-block 8140 executes a process according to S106 as described in the first embodiment except that setting a restriction to avoid a risk is performed by a degradation plan or a restriction plan at the planning block 8120. In such a eighth embodiment, it is possible to set an appropriate restriction on the manually operated host vehicle 2 and ensure the accuracy of the driving control based on the principle equivalent to the first embodiment.

### Ninth Embodiment

The ninth embodiment is a modification of the processing method in which the system configuration of the eighth embodiment is applied to the second embodiment.

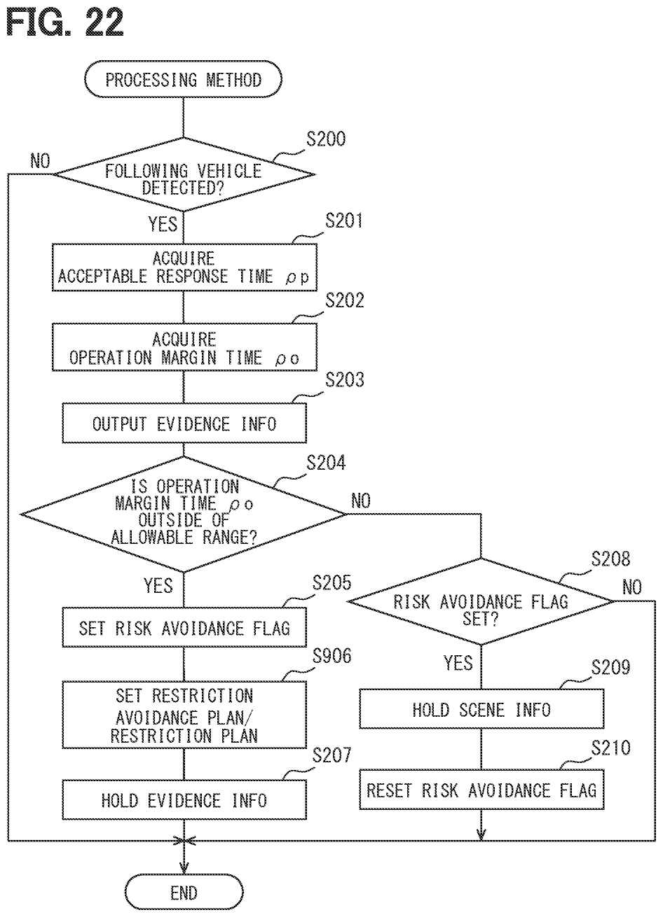

As shown in FIG. 22, at S906 of the processing method according to the ninth embodiment, the risk monitoring sub-block 8140 executes a process equivalent to S206 as described in the second embodiment except that setting a restriction to avoid a risk is performed by an avoidance plan or a restriction plan at the planning block 3120. In such a ninth embodiment, it is possible to set an appropriate restriction on the host vehicle 2 in the automated-driving and ensure the accuracy of the driving control based on the principle equivalent to the second embodiment.

### Other Embodiments

Although a plurality of embodiments have been described above, the present disclosure is not to be construed as being limited to these embodiments, and can be applied to various embodiments and combinations within a scope not deviating from the gist of the present disclosure.

The dedicated computer of the processing system 1 of the modification example may include at least one of a digital circuit and an analog circuit as a processor. In particular, the digital circuit is at least one type of, for example, an ASIC (Application Specific Integrated Circuit), a FPGA (Field Programmable Gate Array), an SOC (System on a Chip), a PGA (Programmable Gate Array), a CPLD (Complex Programmable Logic Device), and the like. Such a digital circuit may include a memory in which a program is stored.

The processing method according to the modified example may be executed by limitedly performing S100 to S103 and S107. In the processing method of the modified example, among S105, S305, S505, S805 and S106, S306, S506, S806, at least S106, S306, S506, S806 may be omitted. The processing method according to the modified example may be executed by limitedly performing S200 to S203 and S207. In the processing method according to the modified example, the execution of S206, S406, S606, and S906 may be omitted. In the processing method according to the modified example, the execution of S108 to S110 may be omitted. In the processing method according to the modified example, the execution of S205, S208 to S210 may be omitted.

In addition to the above-described embodiments, the above-described embodiments and modifications are configured to be mountable on a host mobile body and have at least one processor 12 and at least one memory 10. A processing circuit (for example, a processing ECU, etc.) or It may be embodied in the form of a semiconductor device (e.g., semiconductor chip, etc.).

1. A processing method executed by a processor for executing a process related to driving control of a host moving body, the method comprising:
detecting a manual deviation between a driver's manual operation and a driver's standard operation when the host moving body is under manual-driving; and
outputting an acceptable response time for the host moving body, wherein
the acceptable response time is a response time during which the host moving body is allowed to respond while the manual deviation is generating, and
the acceptable response time is acquired based on a safety model that is a model in compliance with a driving policy and is formed by modeling a safety of intended functionality.

2. The method according to claim 1, further comprising
outputting an operation margin time given to the driver's manual operation in the host moving body, wherein
the operation margin time is acquired based on the acceptable response time.

3. The method according to claim 2, further comprising
storing at least one of the output acceptable response time or the output operation margin time when the operation margin time is determined to be outside of an allowable range.

4. The method according to claim 2, further comprising
setting a restriction/constraint on the driving control to allow automated-driving of the host moving body to intervene in the manual-driving when the operation margin time is determined to be outside of the allowable range.

5. The method according to claim 4, further comprising
setting the restriction/constraint on the driving control to avoid an unreasonable risk for the host moving body under the automated-driving when the operation margin time is determined to be outside of the allowable range.

6. The method according to claim 5, further comprising
setting the restriction/constraint on the driving control to shift the host moving body under the automated-driving to a minimal risk state based on the safety model when the operation margin time is determined to be eliminated.

7. The method according to claim 2, further comprising
updating, based on the operation margin time, a safety distance that is set, according to the safety model, as a distance to a target moving body from the host moving body under automated-driving when the driver's manual operation generating the manual deviation is determined to terminate with the operation margin time within the acceptable range.

8. A processing system that is configured to execute a process related to driving control of a host moving body, the system comprising:
at least one processor programmed to:
detect a manual deviation between a driver's manual operation and a driver's standard operation when the host moving body is under manual-driving; and
output an acceptable response time for the host moving body, wherein
the acceptable response time is a response time during which the host moving body is allowed to respond while the manual deviation is generating, and
the acceptable response time is acquired based on a safety model that is a model in compliance with a driving policy and is formed by modeling a safety of intended functionality.

9. A non-transitory, computer readable, tangible storage medium storing a processing program including instructions causing at least one processor to execute a process related to driving control of a host moving body, the instructions, when executed by the at least one processor, casing the at least one processor to:
detect a manual deviation between a driver's manual operation and a driver's standard operation when the host moving body is under manual-driving; and
output an acceptable response time for the host moving body, wherein
the acceptable response time is a response time during which the host moving body is allowed to respond while the manual deviation is generating, and
the acceptable response time is acquired based on a safety model that is a model in compliance with a driving policy and is formed by modeling a safety of intended functionality.

10. A processing method executed by a processor for executing a process related to driving control of a host moving body, the method comprising:
detecting a target moving body that is following the host moving body under automated-driving; and
outputting an acceptable response time, wherein
the acceptable response time is a response time during which the target moving body is allowed to respond, and
the acceptable response time is acquired based on a safety model that is a model in compliance with a driving policy and is formed by modeling a safety of intended functionality.

11. The method according to claim 10, further comprising
outputting an operation margin time given to an automatic operation in the automated-driving of the host moving body, wherein
the operation margin time is acquired based on the acceptable response time.

12. The method according to claim 11, further comprising
storing at least one of the output acceptable response time or the output operation margin time when the operation margin time is determined to be outside of an allowable range.

13. The method according to claim 11, further comprising
setting a restriction/constraint on the driving control to avoid an unreasonable risk for the host moving body under the automated-driving when the operation margin time is determined to be outside of an allowable range.

14. The method according to claim 13, further comprising
setting the restriction/constraint on the driving control to shift the host moving body under the automated-driving to a minimal risk state based on the safety model when the operation margin time is determined to be eliminated.

15. A processing system that is configured to execute a process related to driving control of a host moving body, the system comprising:
at least one processor programmed to:
detect a target moving body that is following the host moving body under automated-driving; and
output an acceptable response time, wherein
the acceptable response time is a response time during which the target moving body is allowed to respond, and
the acceptable response time is acquired based on a safety model that is a model in compliance with a driving policy and is formed by modeling a safety of intended functionality.

16. A non-transitory, computer readable, tangible storage medium storing a processing program including instructions causing at least one processor to execute a process related to driving control of a host moving body, the instructions, when executed by the at least one processor, causing the at least one processor to:
detect a target moving body that is following the host moving body under automated-driving; and
output an acceptable response time, wherein
the acceptable response time is a response time during which the target moving body is allowed to respond, and
the acceptable response time is acquired based on a safety model that is a model in compliance with a driving policy and is formed by modeling a safety of intended functionality.

17. A non-transitory, computer readable, tangible storage medium storing a storage medium storing, by the method according to claim 3, at least one of the acceptable response time or the operation margin time that are output when the operation margin time is determined to be outside of the allowable range.

18. A processing device that is installable in a host moving body and executes a process related to driving control of the host moving body, the device comprising:
at least one processor programmed to:
detect a manual deviation between a driver's manual operation and a driver's standard operation when the host moving body is under manual-driving; and
output an acceptable response time for the host moving body, wherein
the acceptable response time is a response time during which the host moving body is allowed to respond while the manual deviation is generating, and
the acceptable response time is acquired based on a safety model that is a model in compliance with a driving policy and is formed by modeling a safety of intended functionality.

19. A processing device that is installable in a host moving body and executes a process related to driving control of the host moving body, the device comprising:
at least one processor programmed to:
detect a target moving body that is following the host moving body under automated-driving; and
output an acceptable response time, wherein
the acceptable response time is a response time during which the target moving body is allowed to respond, and
the acceptable response time is acquired based on a safety model that is a model in compliance with a driving policy and is formed by modeling a safety of intended functionality.
